(19) United States
(12) Patent Application Publication
(10) Pub. No.: US 2023/0265571 A1
(43) Pub. Date: Aug. 24, 2023

(54) POLYMER ELECTROLYTE COMPOSITES

(71) Applicant: Ecolectro, Inc, lthaca, NY (US)

(72) Inventors: Kristina Hugar, Ithaca, NY (US); Gabriel Rodriguez-Calero, Willseyville, NY (US); Sarah Nathan, Wilmington, DE (US); Sarah Louise Poole, Syracuse, NY (US)

(21) Appl. No.: 18/020,473

(22) PCT Filed: Aug. 10, 2021
(86) PCT No.: PCT/US21/45302

§ 371 Date: Feb. 9, 2023

Related U.S. Application Data
(60) Provisional application No. 63/063,730, filed on Aug. 10, 2020.

(51) Int. Cl. C25B 13/08; C25B 13/07; C25B 9/23

(52) U.S. Cl. CPC C25B 13/08; C25B 13/07; C25B 9/23

(57) ABSTRACT

The present disclosure relates to composite materials comprising a reinforcement material and a cationic polyelectrolyte, such as a porous reinforcement material impregnated with the cationic poly electrolyte. The present disclosure further relates to membrane electrode assemblies comprising the composites of the disclosure, and electrochemical devices comprising the disclosed membrane electrode assemblies.

### RELATED APPLICATIONS

This application claims the benefit of U.S. Provisional Application No. 63/063,730, filed on Aug. 10, 2020. The entire teachings of the above application are incorporated herein by reference.

### GOVERNMENT SUPPORT

This invention was made with Government support under Grant No. 1746486 awarded by the National Science Foundation (NSF). The Government has certain rights in the invention.

### BACKGROUND OF THE INVENTION

Polymer electrolytes presently used in fuel cells, electrolyzers, redox flow batteries and water purification have low durability, mechanical strength and conductivity. Current materials are not optimized for performance, durability and costs, which reduces the commercial viability of new technologies. Therefore, high-performance polymer electrolytes that are characterized by high ionic conductivity and durability under harsh chemical conditions and in high temperatures

### SUMMARY OF THE INVENTION

In a first embodiment, the present invention is a composite material, comprising a reinforcement material and a polyelectrolyte in contact with said reinforcement material, wherein the polyelectrolyte comprises a first repeat unit selected from a moiety represented by the structural formula I, II, II, or IV:

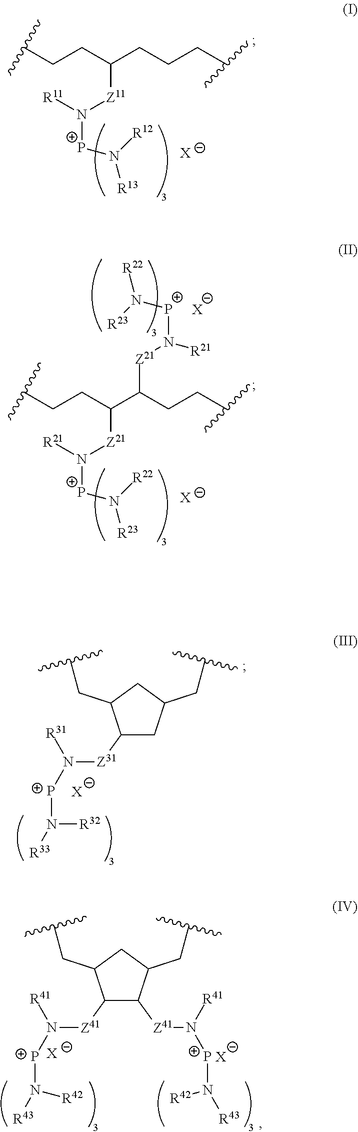

wherein:
[symbol] indicates the point of attachment to other repeat units;
R¹¹, R²¹, R³¹, and R⁴¹, each independently, is a C₁₋₄ alkyl;
R¹², R¹³, R²², R²³, R³², R³³, R⁴² and R⁴³, each independently, is a C₁₋₄ alkyl or a C₅₋₇ cycloalkyl;
Z¹¹, Z²¹, Z³¹, and Z⁴¹, each independently, is a C₁₋₁₀ alkylene or a *O—(C₁₋₁₀ alkylene), wherein * indicates the point of attachment to the polymer backbone;
X⁻ is a halide, OH⁻, HCO₃⁻, CO₃²⁻, CO₂(R¹⁰)⁻, O(R¹⁰)⁻, NO₃⁻, CN⁻, PF₆⁻, or BF₄⁻; and
R¹⁰ is a C₁₋₄ alkyl.

In a second embodiment, the present invention is a membrane, comprising a film of any composite material described herein with respect to the first embodiment and various aspects thereof.

In a third embodiment, the present invention is a membrane electrode assembly, comprising any membrane described herein with respect to the second embodiment and various aspects thereof and an electrode.

In a fourth embodiment, the present invention is an electrochemical device comprising any membrane electrode assembly described herein with respect to the third embodiment and various aspects thereof and a current collector.

### BRIEF DESCRIPTION OF THE DRAWINGS

FIG. 1 shows comparison of properties of an unsupported polymer electrolyte (T-17-80) and a composite comprising the polymer electrolyte and a porous support (MP-37-360).

FIG. 2 shows the structural formula of Tetrakis® polymer.

FIG. 3 shows the reaction sequence for the synthesis of Tetrakis® polymer.

FIG. 4 shows a bar chart demonstrating hydroxide conductivity at room temperature of different polymers containing phosphonium cations and proposed structural variations of Tetrakis® monomer.

FIG. 5 shows a chemical structure of an exemplary cationic polymer synthesized from di-cationic monomers (top); and a plot showing temperature-dependent ionic conductivity of the polymer (bottom).

FIG. 6 shows two synthetic strategies for developing monomers that contain two phosphonium cations.

FIG. 7 shows examples of cyclooctene-based monomers with hydrophobic functional groups.

FIG. 8 shows a chemical structure of a cross-linked ammonium-based Anionic Exchange Membrane (AEM) containing di-cationic segments and a plot demonstrating the relationship between hydroxide conductivity of the polymer and the ratio of cis-cyclooctene COE, CAS #931-87-3) to Cationic monomer (referred to as 1).

FIG. 9 shows a chemical structure of a cross-linking monomer that can stimulate thermal cross-linking, 2-acetoxy-dicyclopentadiene.

FIG. 10 shows plots demonstrating alkaline stability of the Tetrakis® polymer after exposure to different concentrations of KOH at different temperatures.

FIG. 11 shows a schematic depiction of facile ion conduction in AEM composites as opposed to unstructured AEMs.

FIG. 12 shows a table listing physical characteristics of the support materials: PE (polyethelene), PP (polypropylene), PTFE-MP (polytetrafluoroethvlene membranes purchased from Millipore Sigma), and PTFE-HHPS (polytetrafluoroethylene membranes purchased from a Sumitomo Electric under the trade name “HHPS”).

FIG. 13 shows a diagram representing the notation scheme for the Tetrakis® polymer and the corresponding composites.

FIG. 14 shows a schematic representation of the method for preparing polymer electrolyte composites.

FIG. 15 shows EDS map of MP-37-360 stained with iodine. Boxes 1-3 are in the steel shim area and boxes 4-6 are in the composite area. Inset: SEM of the composite held by shims.

FIG. 16 shows elemental spectra with gaussian fit of the iodine absorption at 3.93 keV of a cross-sectional slice of MP-37-360. Inset: SEM cross-section of the area used for the elemental mapping. The red box is the area analyzed.

FIG. 17 shows a bar chart demonstrating ion accessibility of T-17-180, T-37-360, and MP-37-360.

FIG. 18 shows a bar chart demonstrating carbonate conductivity of T-17-180 and MP-37-380 (left); and temperature-dependent conductivity profile of MP-37-360 between 20° C. and 60° C. (right).

FIG. 19 shows a table summarizing room temperature ionic conductivities of T-17-180, T-37-360, and MP-37-360.

FIG. 20 shows a plot demonstrating temperature-dependent thickness of wet MP-37-360, T-17-180, and T-37-360.

FIG. 21 shows a plot demonstrating stress-strain curves of PTFE-MP support, MP-37-360 (wet & dry), and T-37-360 (wet).

FIG. 22 shows a plot demonstrating thermal gravimetric analysis (TGA) of the PTFE support, T-37-360, and MP-37-360.

FIG. 23 shows a plot demonstrating ion accessibility MP-37-360 over 1000 hours.

FIG. 24 shows examples of porous supports, fabrication methods, and their impact on morphology of the supports.

FIG. 25 shows examples of pore size in porous materials.

FIG. 26 shows examples of different porosity of porous materials with the same pore size.

FIG. 27 shows examples of composites with different void volumes.

FIG. 28 shows steps of manufacturing of membrane electrode assembly (MEA): preparation of the catalyst ink (A); preparation of electrodes using a film applicator technique (B); and preparation of a catalyst coated membrane (CCM) using decal transfer (C).

FIG. 29 shows a catalyst coated MP-37-360 after testing.

FIG. 30 shows a flow chart for the MEA fabrication process.

FIG. 31 is a polarization plot of an MEA in electrolyzer mode.

FIG. 32 shows a plot demonstrating durability of MEA after 17 hours.

FIG. 33 shows polarization curve of MEA with 0.12% ionomer in CCM at 50° C. (top) and at 70° C. (bottom).

FIG. 34 shows polarization curve of MEA with 0.12% ionomer in CCM at 70° C.

FIG. 35 shows a table listing CO₃²⁻ conductivities for PTFE-MP and PP-based composites under different removal conditions.

FIG. 36 shows CO₃²⁻ conductivities of composites made with different support materials using T-37-360.

FIG. 37 shows SEM images of different porous supports.

FIG. 38 shows polarization curve of T-17-180.

FIG. 39 shows plots demonstrating dynamic mechanical analysis (DMA) of support materials PE, PP, and PTFE-MP in tensile test configuration (left); and thermal gravimetric analysis (TGA) of PP, PE, and PTFE-MP (right).

### DETAILED DESCRIPTION

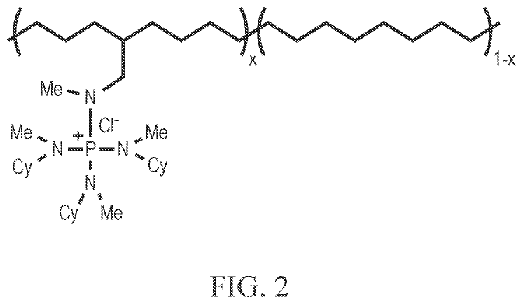

Developing AEMs that contain durable polymer backbones and cationic groups is required to commercialize fuel cells, electrolyzers, redox flow batteries, water purifiers and other electrochemical devices. Alkaline systems hold several benefits over acidic counterparts, particularly the fabrication of devices with less expensive electrodes and bipolar plates and longer lifetimes. Alkaline electrochemical devices are an exciting alternative to proton exchange membrane (PEM) devices because at elevated pH, oxygen reduction is more facile and lower overpotentials are required, and allowing metals other than platinum to be used as electrocatalysts. Phosphonium-containing polyelectrolytes, such as Tetrakis® polymer shown in FIG. 2, are an enabling component deeply needed for the widespread adoption of alkaline electrochemical devices.

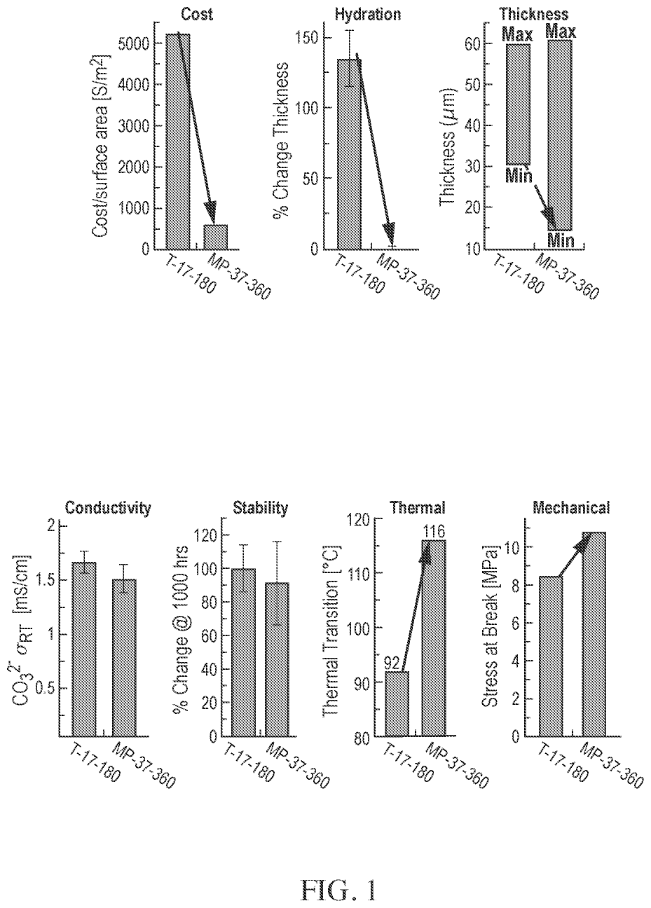

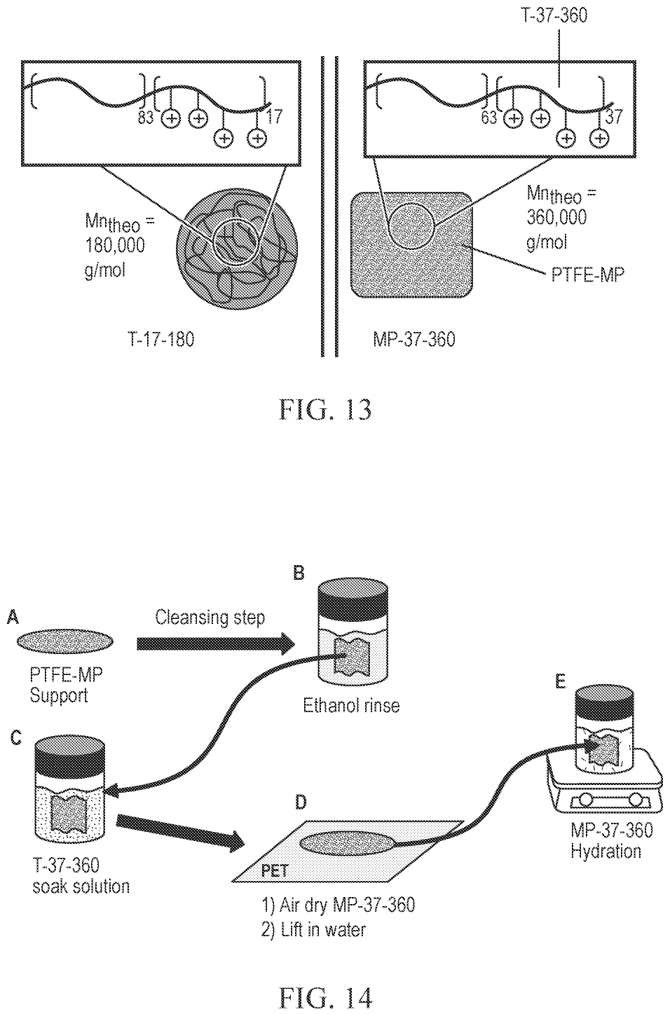

Disclosed herein are composites comprising a phosphonium-containing polyelectrolyte and a reinforcement, such as MP-37-360 (FIG. 13). The composites exhibit a number of advantages over the support-free AEMs, as shown in FIG. 1. A composite comprising a polyelectrolyte and a reinforcement is advantageous since the mechanical and chemical durability of the reinforcement can be optimized separately from the optimization of ionic conductivity of the polyelectrolyte. Therefore, the final composite can benefit from the synergy of the customized properties of the reinforcement and the finely-tuned conducting abilities of the polyelectrolyte.

The composites demonstrate high ionic conductivity, matching a similar support-free AEM (T-17-180, FIG. 13), with significantly less polyelectrolyte material in the composite, <5% by weight. The low polymer loading results in a dramatic decrease in the cost of goods for making the composite, compared to unsupported membranes. Moreover, the composites show considerably less swelling (136% less) in 80° C. water with improvements in the mechanical and thermal properties. The composites were chemically stable over 1000 hours in 1 M KOH at 80° C. Furthermore, Membrane electrode assemblies (MEAs) were successfully fabricated using MP-37-360 composites and ionomers. The MEAs were tested in fuel cell configuration and achieved a maximum current density of 520 mA/cm2 at 80° C.

Polymer Electrolytes.

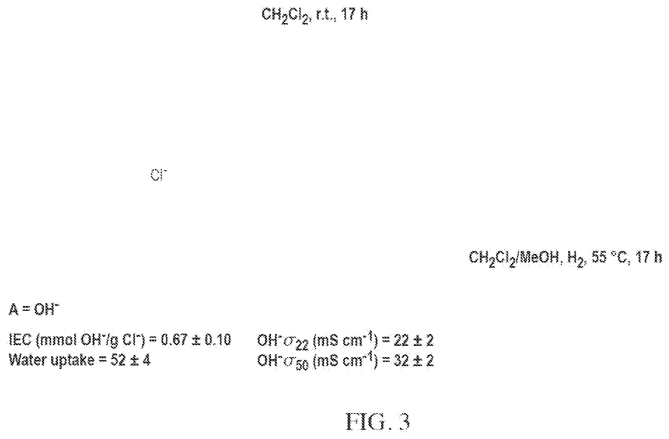

In some embodiments, polymer electrolytes are composed of tetrakis(dialkylamino) phosphonium cations appended to non-aromatic, hydrocarbon backbones that are essentially modified polyethylene (FIG. 2 shows an exemplary Tetrakis® polymer). Polymers containing the tetrakis(dialkylamino) phosphonium cations were prepared with ring-opening metathesis polymerization (ROMP) of cis-cyclooctene and functionalized cyclooctene using Grubbs' 2nd generation catalyst, as shown in FIG. 3. This powerful synthetic tool uses a functional group tolerant catalyst that is capable of directly polymerizing cationic monomers to full conversion (≥98%) under mild conditions (22° C.) and with short reaction times (<24 hours).

Copolymerization with non-functionalized monomers permits precise modulation of the cation content in the polymer product by merely changing the ratio of the two monomers. Polymer molecular weight is easily adjusted by changing the amount of catalyst added, producing polymers with high average molecular weight. This approach contrasts with typical synthesis of AEMs that uses step growth polymerization techniques with long reaction times and aggressive conditions to achieve modest conversions. Other common approaches involve fluoropolymer synthesis, which is energy intensive and uses toxic reagents. Moreover, the polymer backbone of the presently disclosed polymers does not contain functional groups that degrade under alkaline conditions like other AEMs. The resulting polymers are generated with accurate and highly reproducible compositions, optimized for ionic conductivity, chemical stability, processability, and mechanical properties.

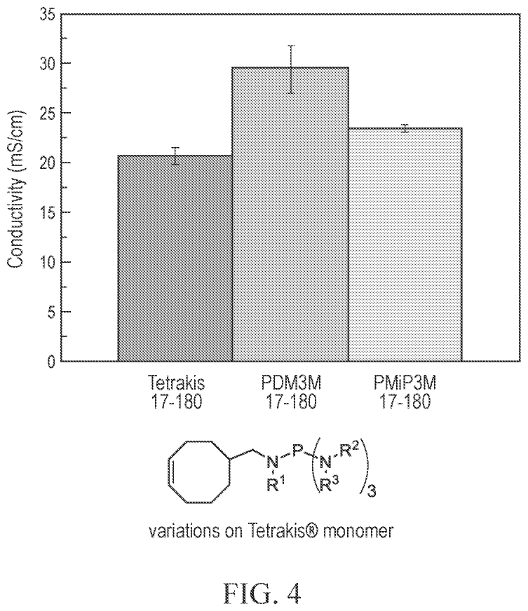

The chemical structure of AEMs, which include the polymer backbone and pendent functional groups, are directly responsible for the electrochemical performance, mechanical properties, and the chemical durability. A high-performance AEM that meets all the strict requirements for a competitive commercial product is only achieved by tuning the chemical structure of the polymers. Modifications of the standard phosphonium cation in the Tetrakis® monomer, which includes methyl and cyclohexyl nitrogen substituents results in higher hydroxide conductivity at room temperature, as shown in FIG. 4. The structures of the PDM3M and PMiP3M polymers are shown below:

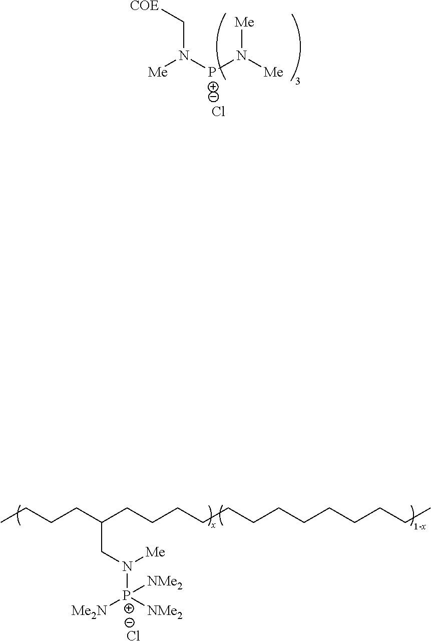

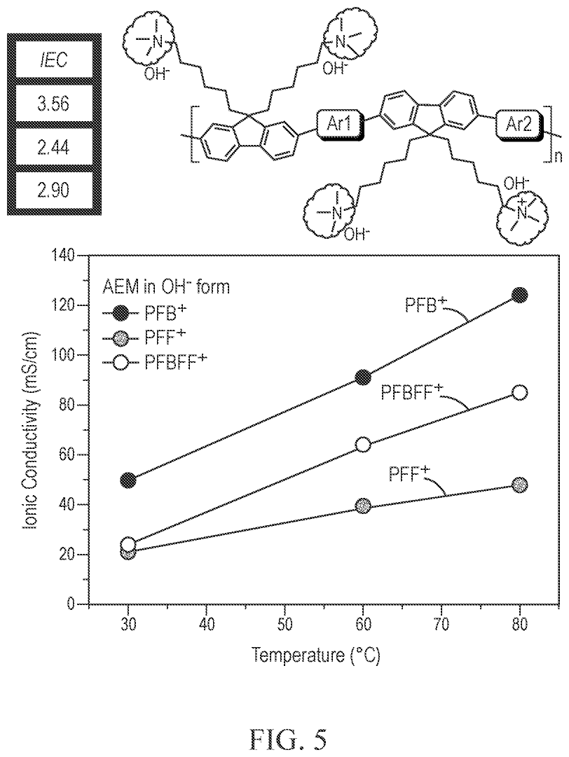

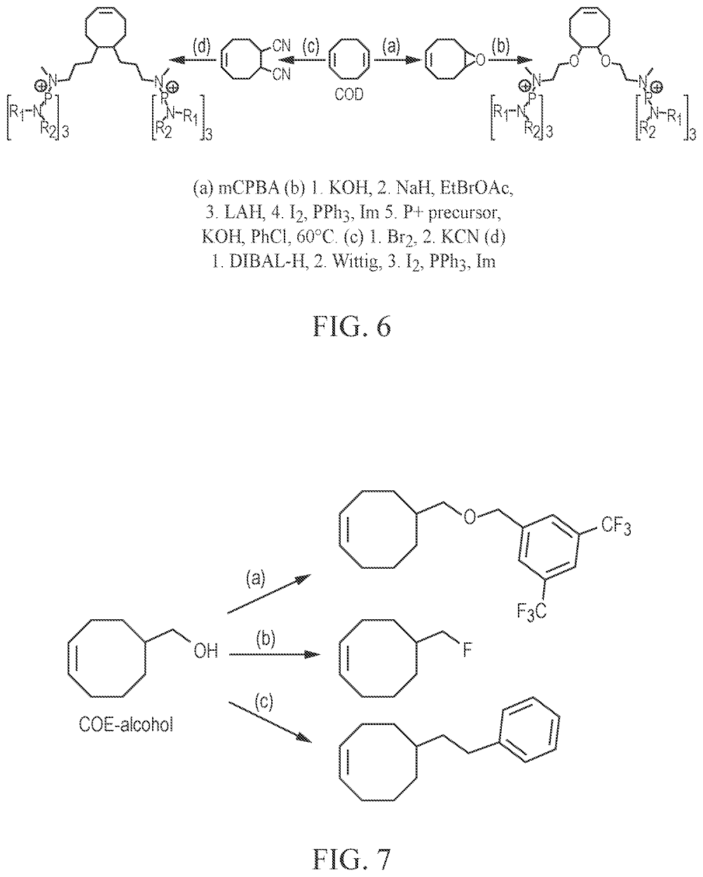

Increasing the ion exchange capacity (IEC) is a proven method to raise the ionic conductivity of AEMs. Polymers with large charge density contain more sites for efficient ion mobility. However, polymers with high IEC can swell excessively causing AEM failure. Higher IECs are often achieved by changing the ratio between the cationic monomer and structural comonomer. Yet, the maximum IEC obtained with this method alone is typically limited (<1.5 meq/g). Preparing monomers with two cations (di-cations) or introducing two cations into one repeat unit of the polymer is an effective strategy to raise IEC beyond the typical limits and; therefore, raise the ionic conductivity. An example is shown in FIG. 5, where high IEC (2.5-3.5 meq/g) resulted in very high hydroxide conductivity (120 mS/cm at 80° C.). The Tetrakis® monomer can be similarly modified to carry two cationic moieties in one monomer. Two strategies for developing ROMP monomers that contain two phosphonium cations are presented in FIG. 6. Both examples are equally obtainable and there are no foreseeable challenges with the syntheses. The route towards the compound on the right includes an additional ether functional group in the monomer that may provide an advantage. Including hydrophilic features on or near the cationic groups has been shown to hydrate the cation better, increasing conductivity and stability.

Phase separation in polymers that contain segments of immiscible components has been shown to improve the performance of AEMs. The excellent electrochemical properties of Nafion® have been attributed to the micellular structure observed for the fluorinated chains capped with sulfonate ions. In AEMs, it is often achieved by preparing block copolymers with microphase separation and obtaining distinct morphologies. Unfortunately, these methods are not compatible with all polymerization techniques and it has yet to be achieved for aliphatic hydrocarbon copolymers. Another method to promote phase separation between structural and functional segments of AEMs is to increase the hydrophobicity of the non-cationic part. This is possible by incorporating long-chain hydrocarbons, aromatic groups and fluorinated moieties. It can be achieved by polymerization of hydrophobic ROMP monomers to induce phase separation in the phosphonium AEMs; thereby improving the conductivity. Examples of cyclooctene-based monomers with hydrophobic functional groups are presented in FIG. 7.

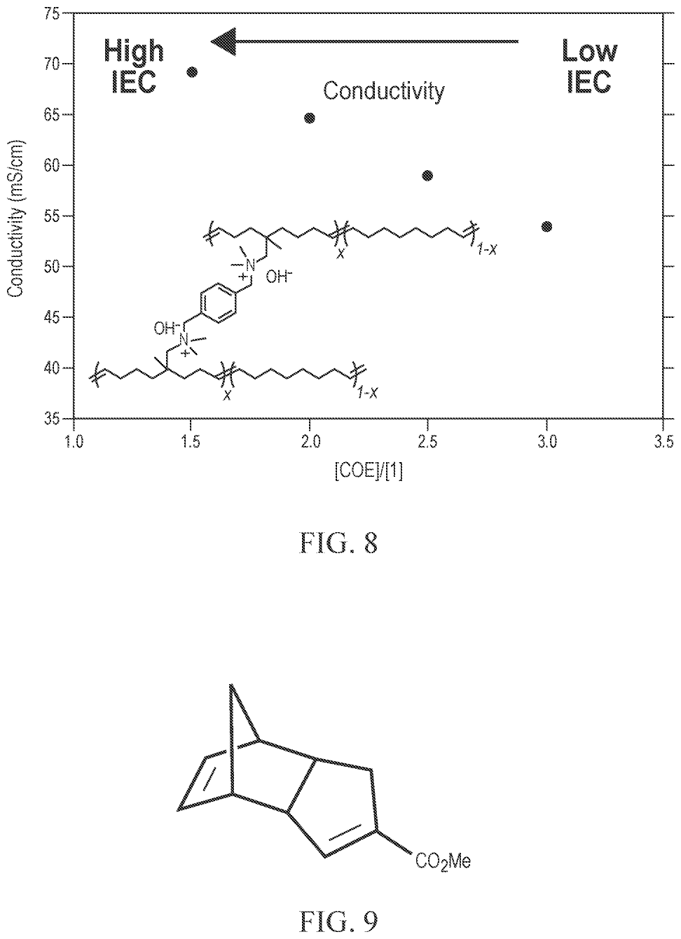

The virtues of increasing AEM charge density are diminished if the polymers affinity for water is too great. Some water uptake is necessary for proper ion transport, yet too much swelling has negative impacts. It reduces the mechanical properties of unsupported AEMs, and 3D swelling lowers ionic conductivity by increasing the distance ions travel. Large changes in the dimensions of the polymer during humidity cycling increases the stress forces on membranes and is particularly problematic for fuel cell electrolytes. Moreover, AEMs can become water soluble at very high IECs. Reinforced AEMs (composites) are less susceptible to the mechanical issues, but water solubility remains a problem. Even though increasing the polymer molecular weight is easily accomplished with the disclosed polymerization procedures, further modifications are needed to inhibit aqueous solubility at optimal IEC values. Cross-linking polymers is a common way to completely prevent solubility. An example of a cross-linked ammonium-based AEM that also contains di-cationic segments is shown in FIG. 8. High IEC and hydroxide conductivity were observed for these insoluble AEMs that also had stronger mechanical properties. These AEMs were prepared with a monomer that cross-linked the polymer during polymerization. While efficient, this method doesn't allow for the processing that is needed to incorporate the polymer into a mesoporous support. To cross-link after polymerization, functional groups that react with thermal or UV energy must be integrated into the polymer during synthesis. There are a variety of functional groups that are commonly used for thermal or UV curing. An example of an established ROMP monomer that can stimulate thermal cross-linking, 2-acetoxy-dicyclopentadiene, is shown in FIG. 9. Since Grubbs' ROMP catalyst is functional group tolerant, multiple cross-linking monomers that remain stable under alkaline conditions can be explored.

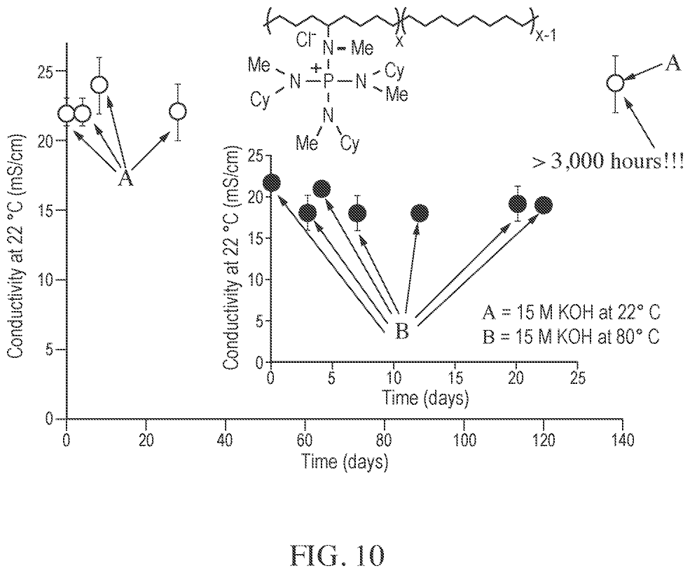

To demonstrate the exceptional chemical stability of the phosphonium AEMs, Tetrakis® polymers were treated with aggressive alkaline conditions (15 M KOH(aq) at 22° C. or 1 M KOH(aq) at 80° C.). The in-plane hydroxide conductivity (at 22° C.) was measured over 1,000-3,000 hours of exposure. Significant changes in conductivity were not observed for these polymers, as shown in FIG. 10, which indicates that these membranes will have excellent chemical durability in operating devices.

To make the AEMs even more compelling, it is important to reduce overall resistance by decreasing the thickness of the electrolyte layer and increasing ionic conductivity, without sacrificing mechanical strength. Conventional methods to increase conductivity involve increasing the ion content in the polymer or IEC. This strategy is easily accomplished with the ROMP technique. However, higher ion content results in higher water uptake and excessive swelling of the polymer electrolyte, resulting in mechanical failure. Certain AEMs are pliable films that are not brittle at reduced thickness but swelling of such membranes in water at high temperatures can make them too viscoelastic. Including an additional facet to the system that simultaneously allows for higher IEC of thinner electrolytes, mechanical strength, and reduced dimensional changes in the hydrated electrolyte produces desirable AEM products.

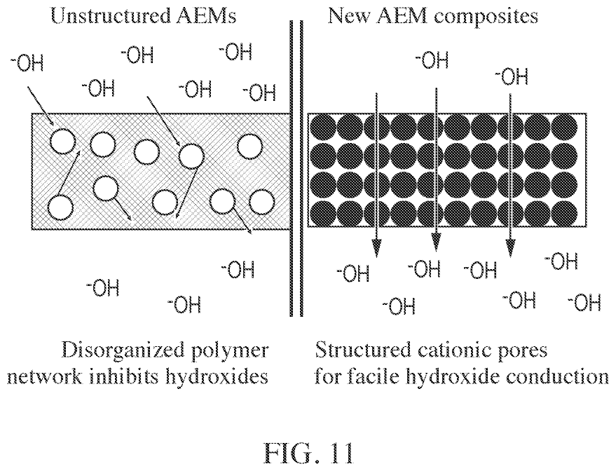

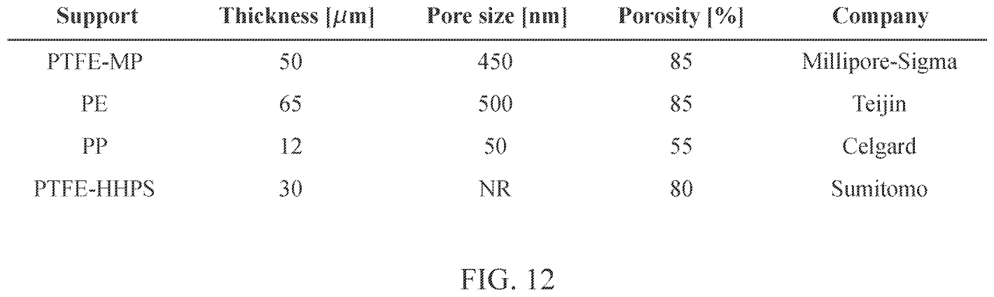

In some embodiments, the desired thinner electrolytes comprise composite AEMs by filling porous polymer supports with the phosphonium-containing AEM materials. Polyethylene (PE), polypropylene (PP) and polytetrafluoroethylene (PTFE) structural supports were selected to investigate the impact of the support materials on the resulting composites (FIG. 12) In addition to permitting higher IEC, porous composites may provide a less tortuous path to facilitate the passage of anions through the electrolyte layer, further boosting performance, without compromising mechanics or stability (FIG. 11). Unsupported Tetrakis® membranes can be prepared to 30 μm thickness and make films that are easy to handle and manipulate. However, using supports allows for a wider range of thicknesses by casting membranes into thin, composite materials.

AEMs are composed of inherently stable polyethylene-like backbones and phosphonium moieties. These features exhibit unprecedented chemical durability under the most aggressive conditions, making AEMs with these features very strong candidates for high-performance products. However, while chemically resistant, polyethylene is known to be viscoelastic (low stress tolerance) and deforms at temperatures around 100° C. (low heat tolerance). As described herein, the mechanical and thermal properties of the disclosed composites are much higher than the unreinforced AEMs, mimicking the support characteristics.

Two methods of filling the support with the phosphonium-containing AEM materials are provided: 1) submerging in solutions containing pre-formed polymers and 2) conducting the polymerization reaction inside the support. Mesh supports will be submerged in solutions of Tetrakis® polyelectrolyte solutions to fill the pores of the composite. Due to the flexibility of the polymerization method (ROMP), the polymerization step can also be completed inside the polymer mesh. Composites prepared via both methods were characterized to determine the simplest path to proof-of-concept. The composites produced were characterized with a number of ex-situ techniques to understand how well the AEM materials penetrated the support and the properties of the resulting composites. Imaging techniques, differential weight analysis, and IEC measurements provide information about how much polymer is inside the support material. Performance was evaluated by ionic conductivity, water uptake, mechanical testing, thermal analysis and chemical stability. The optimized polymer electrolyte composites were fabricated into membrane electrode assemblies (MEAs) and the performance in fuel cell configuration were assessed. In-situ performance of these early prototypes is necessary to develop a clear plan for further optimization, including polymer support selection, AEM composition, and methodology for generating the composites. Each of these steps are critical to achieve an AEM product that meets the challenging demands for device performance and penetrate competitive markets.

Porous Supports.

The present disclosure provides methodology of infusing the phosphonium AEM material into the unoccupied spaces within various porous polymer structural supports. The structural rigidity and mechanical strength of the supports was successfully combined with the electrochemical properties of the polymer electrolytes. The resulting composites were fully characterized to analyze the level of polymer impregnation, water uptake levels, thermal characteristics and electrochemical performance. Polymer materials from several international companies were obtained, including polyethylene (PE), polypropylene (PP) and polytetrafluoroethylene (PTFE) supports with the properties described in FIG. 12.

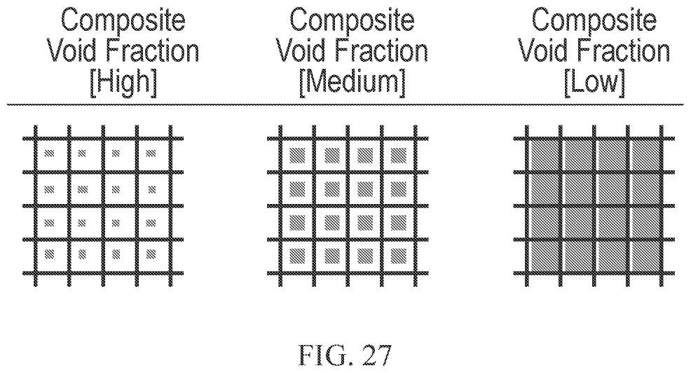

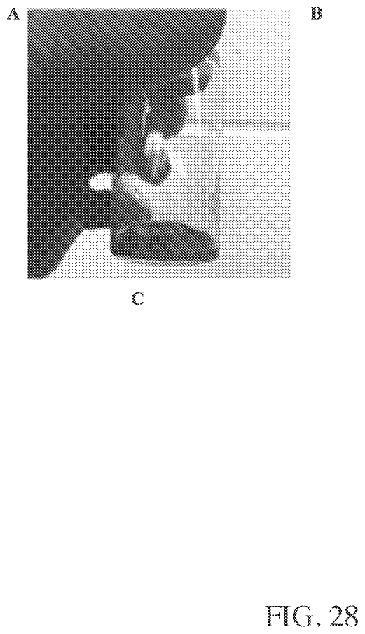

There is an optimum amount of void space remaining in the dry AEM composite after fabrication. Essentially, the bare porous supports have a defined amount of pore volume. During fabrication, the AEM material is dissolved in a solvent that is compatible with the support and then the mixture is applied to the support to fill the pores of the support material. When the solvent is removed, the dry composite has a new void volume. The reinforced AEMs are hydrated prior to use in electrochemical devices and the polymer embedded in the support swells, once again filling much of the void space. A specific amount of void space is needed in the dry AEM to maintain high density of cations for ion transport, but also contain the right amount of space for water. The precise amount of void space will be unique to each type of polymer electrolyte and porous support combination (FIG. 27).

BET can be used to analyze how void volume changes from the bare support and the dry composite. The primary variables to tune the void space are solvent identity and concentration of polymer in solution, as well as the method of introducing the solution to the support matrix. The solvent selected must be compatible with the support polymer and solubilize the AEM to the desired level. Often co-solvent mixtures are explored as well. The concentration must also be optimized because excessively high concentrations may prevent AEM getting into the support and not enough AEM will penetrate the support if it is too low. A rheometer can be used to characterize the viscosity of the polymer solutions and a Zetasizer to analyze the uniformity and dispersion of polymer particles. Measuring these solution properties, which impact the quantity and distribution of AEM in the support, aids in composite optimization. The ionic conductivity can be measured in conjunction with void volume to establish the link between the physical property and the electrochemical performance.

Porous polymer supports are typically designed for filtration and separation of solids, liquids and gases or to sterilize biological solutions, and are not optimized to be filled with another polymer to generate high-performing components for electrochemical devices. Generally, optimizing the specifications of supports for these applications does not provide enough overlap for the class of supports needed for composites. Therefore, it is important to develop polymer supports that are uniquely designed with composites as the end application in mind.

The first consideration to custom design a support for composites is determining what polymer material to use. PTFE, PE and PP are polymers with high chemical resistance. The best thermal properties are observed with PTFE; however, it is a very expensive raw material, that is not recyclable and the processing method to fabricate porous materials from PTFE is limited to expanding. PE and PP are both significantly less expensive than PTFE, they are both recyclable and can be processed using many types of methods. The thermal properties are much lower than PTFE, but this disadvantage can be addressed by cross-linking the polymer electrolyte inside the support.

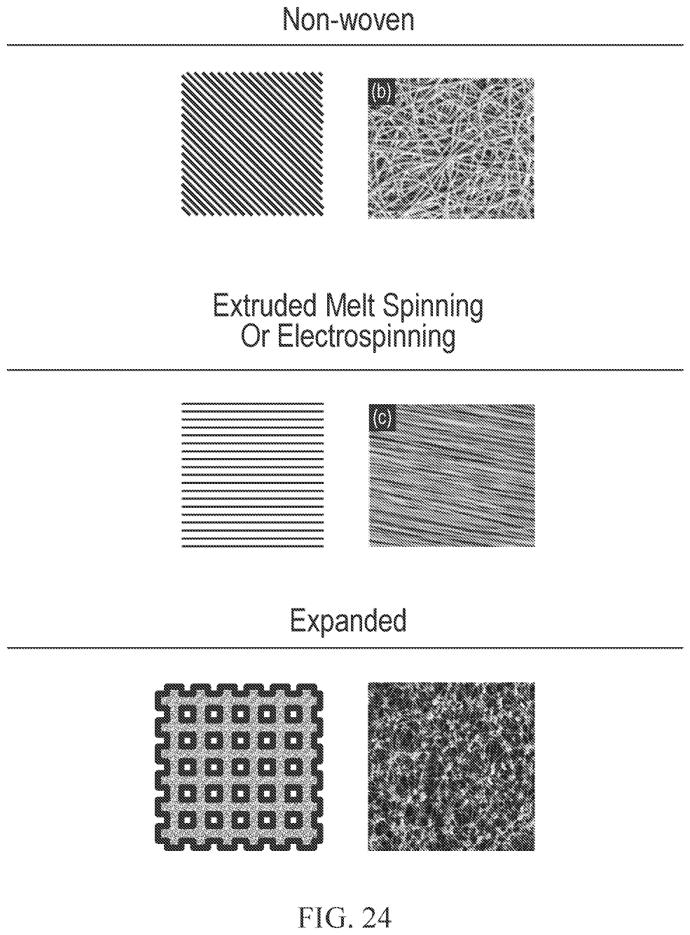

The next consideration for designing the custom support is selecting the fibers and method of fabricating the fibers into mats or sheets of material. The method can be limited for some polymers, for example PTFE can only be expanded into sheets. PE and PP films can be prepared with a variety of polymer fabrication methods. The type of fabrication has a significant impact on the morphology and alignment of the polymer strands (FIG. 24). These features can influence how the polymer electrolyte interacts with the support and how readily it fills the voids, thus influencing composite performance. Furthermore, the mechanical properties of the support will change based on the diameter of the fibers used and how they are arranged in relation to each other, impacting the composite durability. Both features must be considered to obtain the best characteristics in the final material. The overall thickness of the support must be designed as well. Preliminary results indicate that AEMs with lower thickness also have lower resistance (A 57 m thick AEM had a resistance of 256 mΩ while a 74 m thick AEM had a resistance of 458 mΩ).

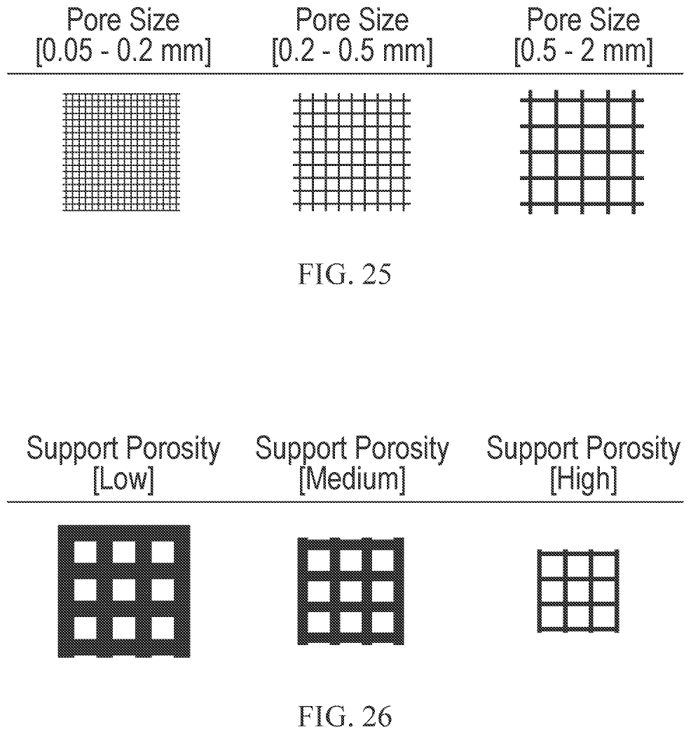

Additional features of porous supports that can be customized include pore size and porosity. Pore size simply indicates how large the average pore sizes are in a given section of support. Porosity indicates how much of the volume inside a given area is free volume, versus taken up by the support. Porosity is another way to characterize the free volume of the bare support. Both of these features will impact how the polymer electrolyte fills the voids in the support and the resulting mechanical strength of the composites. Representations of how these qualities relate to each other are presented in FIGS. 25 and 26.

The pore size and porosity of the supports are measured with BET, before and after filling with polymer electrolyte, to verify fabrication methodology and to support development of optimized composites. Dynamic light scattering (DLS) with a Zetasizer and rheology measurements are useful to characterize dip-coating solutions and catalyst ink formulations.

Optimization of Polymer Composition.

All polymer compositions were synthesized using ring-opening metathesis polymerization (ROMP) of cis-cyclooctene and functionalized cis-cyclooctene using Grubbs' 2^{nd} generation catalyst, as shown in FIG. 3. Synthesis if the Tetrakis® monomer and Tetrakis® polymer is described, for example, in Noonan, K. J. T.; Hugar, K. M.; Kostalik, H. A., IV; Lobkovsky, E. B.; Abruna, H. D.; Coates, G. W. J. Am. Chem. Soc. 2012, 134 (44), 18161-18164. In some embodiments, Tetrakis® AEMs have 17% cation content, with a molecular weight of 180,000 g/mol—designated as T-17-180. To increase the conductivity, the percent cation content in the polymer can be increased by simply increasing the percentage of functionalized cis-cyclooctene in the polymerization. The polymer molecular weight was increased as the cation content increased to decrease water solubility which is undesirable in AEMs. The highest molecular weight explored in the current optimization was 360,000 g/mol; although, higher molecular weights can be obtained with the polymerization method disclosed herein. After synthesizing several polymers with high cationic monomer content (50%-72%), which were soluble in water at 80° C., polymer with 37% cation content was chosen for further studies. However, higher cation contents are possible, especially with higher molecular weight polymers. To establish feasibility of the AEM composites, develop protocols for composite preparation, and characterize early prototypes, a Tetrakis® polymer with 37% cation, 360,000 g/mol molecular weight, was selected and designated as T-37-360 (shown in FIG. 13).

Preparation of Composites.

For each of the commercial supports investigated (FIG. 12), composites were prepared with the method described in FIG. 14. The supports were cleaned in ethanol (A and B) to remove contaminants from manufacturing. Then to fill the supports with polymer, they were soaked in a solution (85 mM T-37-360 in 4:1 ethanol:toluene) at room temperature overnight (C). To remove organic solvents, the composites were air-dried on a polyethylene terephthalate (PET) backing. When dry, the final AEM composite was lifted from the backing by adding water (D). To prepare for characterization, the composites were hydrated at 80° C. in water overnight (E).

Several criteria in the disclosed method required optimization. The polymer soak step (C) was optimized by varying the co-solvent mixture, polymer concentration and support loading (in mmol polymer/surface area of support). Other variables that have an impact are the temperature of the soaking solution and rate of stirring. The best results were obtained with room temperature solutions that were not stirred. To optimize the drying step (D), the composites were laid out on different backing materials, either glass or PET, and air-dried to remove the organic solvents. Significant differences were observed in performance based on how flat the composites were during the drying step. The composites that were smooth, without significant wrinkles or folds gave the best results; while “crumpled” composites had significantly lower conductivity. The best method of removing the composite from the backing material involved hydrating the composites in water at ≥60° C. Gentle mechanical peeling with tweezers to remove the composites from the backing greatly reduced the sample performance. PET backing was used because the PET backing was easier to handle than glass and the composites typically lifted easier from the PET. The temperature and time of hydration in water (step E) was also varied. Temperature (60° C. versus 80° C.) did not appear to have an effect, however the length of time for maximum performance was found to be ≥6 hours. The critical variables for AEM composites were the concentration of polymer solution, the amount of composite in solution and the method of removing the composites from the backing material. The optimal amount of polymer in soak solution per composite surface area should be optimized for each support, since it depends on the interior surface area of each support type. Utilizing the method outlined above, composites were prepared using porous PTFE filters from Millipore-Sigma and Tetrakis® polymer, T-37-360. These composites are designated MP-37-360 herein.

Verification of Polymer Penetration into Support.

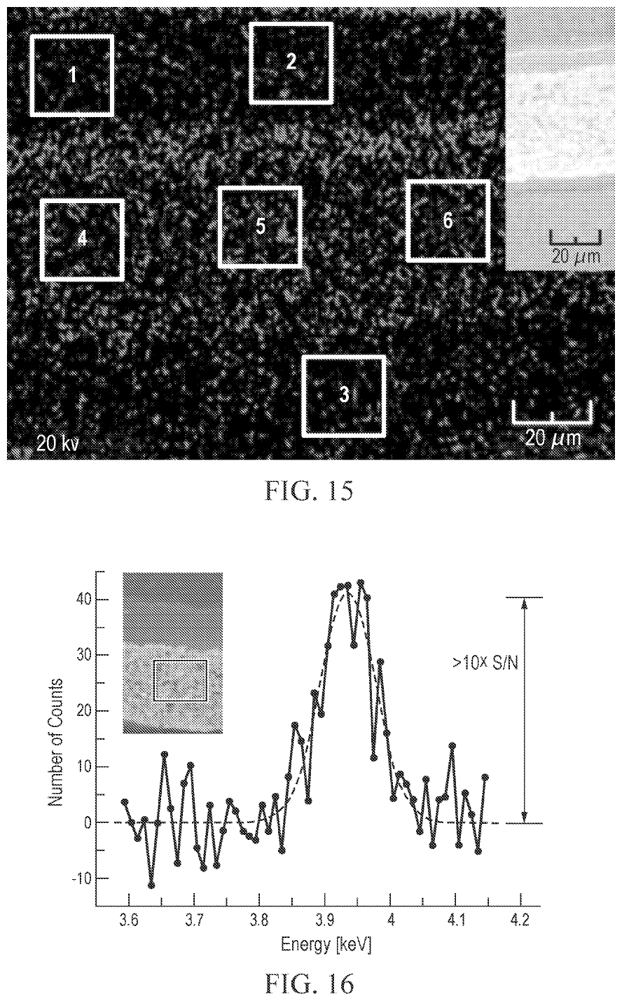

To verify the penetration of the T-37-360 into the support, cross-sectional scanning electron micrographs (SEM) with elemental mapping (EDS) were obtained. To increase elemental contrast, MP-37-360 samples were stained with iodide ions. Hydrated MP-37-360 composites were a) soaked in 1M KOH for 40 minutes b) soaked in 1M KI for 120 minutes, exchanging for fresh 1M KI solution every 40 min, then c) soaked in DI water for 60 min, exchanging for fresh water every 20 min. MP-37-360 in the iodide form was air dried and analyzed by SEM (FIG. 15). The samples were mounted in steel shims, sputtered with a thin layer of gold and imaged at an accelerating voltage of 20 keV. Smooth cross-sections were observed by previous researchers to indicate loss of porosity, in composite SEM images. Some porosity was retained in MP-37-360, as shown by the roughness in the centers of FIG. 15 (inset) and FIG. 16 (inset). Iodine levels within the MP-37-360 sample were analyzed with elemental spectroscopy. The sample was mounted between steel shims and trace amounts of iodine within the steel can be seen along the top and bottom of the image (FIG. 15, areas 1-3). This elemental map shows a relatively uniform distribution of iodine along the cross-section (FIG. 15, areas 4-6). Analysis of the cross-sectional slice of composite by EDS and the spectra shows a strong absorption at 3.93 keV, which is characteristic of iodine (FIG. 16). The strength of the absorption is over 10× the signal to noise ratio (S/N), indicating it is a real signal.

Characterization of Polymer and Ion Content in Composite.

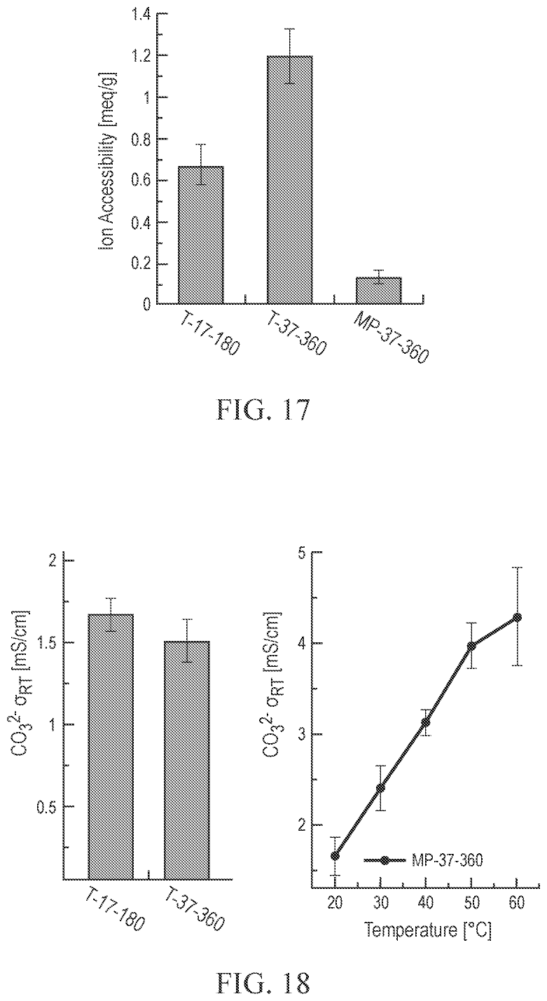

After verifying that the polymer penetrates into the supports, the amount of polymer within the MP-37-360 composites was analyzed. The mobility of ions in composites is dependent on the polymer imbedded within the support—the support alone is non-conductive. The support materials were weighed before and after filling with T-37-360 to determine how much polymer penetrated MP-37-360 and via this method the polymer content was ˜2% by weight. To analyze the accessibility of the ions within the T-17-180 and T-36-360 polymer, a back-titration was performed to determine the IEC. Briefly, the polymers were dried under vacuum overnight and weighed to determine their dry mass. The polymers were exchanged to the hydroxide form, rinsed with water, and soaked overnight in a precisely known amount of hydrochloric acid. The residual HCl solution was then back-titrated to determine the amount of hydroxide ions that exchanged within the polymer. The ratio of hydroxide (mmol) to grams of dry polymer provides a measure of how accessible the polymer is to ions (IEC, Equation 1). T-17-180 has an IEC of 0.67 meq/g and T-37-360 has an IEC of 1.20 meq/g; this difference indicates the increased cation content results in increase cation accessibility, as expected. For composite membranes, the IEC is less straightforward because the mass of the sample is a sum of the dry weight of the support plus the polymer. Therefore, this experiment describes the ion accessibility in the composite (IA, Equation 2) of the polymer within the support. The ion accessibility of MP-37-360 composites was measured to be 0.10 meq/g (FIG. 17). Increasing the amount of polymer within the composite will increase ion accessibility and result in even higher conductivity.

$$IEC = \frac{meq {OH}^{-}}{Dry weight of polymer} \qquad Equation 1$$

$$IA = \frac{meq {OH}^{-}}{Dry weight of support + polymer} \qquad Equation 2$$

Evaluation of Ionic Conductivity of Composites.

A functional property of polymer electrolytes is to conduct ions. In an operating fuel cell, hydroxide anions travel through the membrane from the cathode to the anode, necessitating the use of a polymer electrolyte in these types of devices. To analyze the ability of MP-37-360 composites to conduct anions, through-plane ionic conductivity of MP-37-260 was measured. The orientation chosen is most similar to the orientation used in membrane electrode assemblies and complete devices. It is important to note that ionic conductivity is dependent on orientation. For example, reinforced Nafion XL has an in-plane conductivity of >72 mS/cm and >50.5 mS/cm for through-plane geometry.

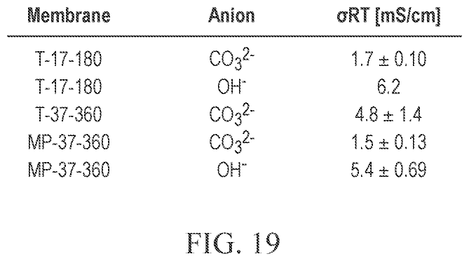

Through-plane conductivity of T-17-180 membranes, T-37-360 membranes, and MP-37-360 composites were analyzed (see FIGS. 18 and 19 and Equation 3). The AEMs were clamped between two carbon coated gas diffusion layers inside two graphite blocks containing serpentine flow fields. A small oscillating voltage (amplitude=10 mV) was swept from 1 MHz to 100 Hz and applied to one side of the membrane and the current response was measured using a Gamry 1000E potentiostat in EIS mode. The resulting Nyquist plot was fit using an inductance-corrected constant phase element with diffusion model and the high-frequency real resistance was used as the cell resistance. The conductivity (σ) was calculated using the bulk resistance (R), the membrane active area (L), and the membrane thickness (A) (Equation 3).

$$σ = \frac{L}{A \times R} \qquad Equation 3$$

Both hydroxide and carbonate ion conductivities were measured; the anions were exchanged using the ion exchange procedures described previously. Potassium carbonate and potassium hydroxide were used for carbonate and hydroxide anion exchanges, respectively. As expected, the hydroxide conductivity of the composite is significantly higher than the carbonate conductivity (FIG. 19). Reinforced AEMs are known to have hydroxide conductivities ranging from 2 to 60 mS/cm, depending on the polymer utilized. Temperature dependent conductivity was measured for MP-37-360 composites from 20° C. to 60° C. Higher temperatures (>60° C.) were not possible due to reaching the detection limit of the potentiostat and limitations of the heating equipment. However, the measurements provided important insights to how the membranes might respond in devices.

Hydration Analysis of Composites.

Two of the advantages of utilizing a composite membrane instead of a polymer membrane are 1) decreased swelling due to water uptake and 2) enhanced mechanical properties. Hydration of AEMs is critical for mobility of hydroxide ions through the membrane; however, excessive swelling can negatively impact the mechanical properties of the polymer film. Moreover, large changes in the AEM dimensions as the electrochemical system goes through temperature and humidity cycling can result in cell failure. To understand the forces that a membrane experiences under operating conditions and the impacts on the physical/mechanical properties, the swelling (i.e. change in dimension; where X=length; Y=width; Z=thickness) and water uptake (i.e. the mass of water that is absorbed) must be determined. Generally, this is determined by measuring the dimensions and weight of a polymer sample in the dry halide form and assessing the changes when converted to the hydrated hydroxide form.

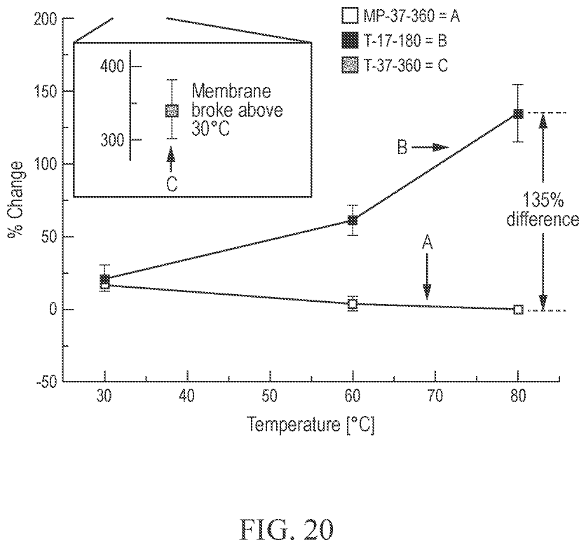

Water uptake was analyzed by heating the composite in water overnight at a constant temperature. The thickness was determined and compared to dry measurements (Equation 4). T-17-180 showed significant swelling up to 80° C., and T-37-360 swelled so much it disintegrated above 30° C. However, the MP-37-360 composites did not change significantly over the temperature range (FIG. 20). This verifies that supporting phosphonium-containing polymers reduces detrimental, temperature-dependent membrane swelling.

$$\% WU = \frac{Wet - Dry}{Dry} \qquad Equation 4$$

Evaluation of Mechanical Properties of Composites.

The mechanical properties of an AEM are significantly influenced by the type of polymer backbone (i.e. fluoropolymer, polyaromatic, polyolefin, polyaryletherketone, etc.), the molecular weight, the identity of the cation (i.e. ammonium, imidazolium, phosphonium, etc.) and cation content (IEC). AEMs that can be processed into thin films are desired because they have lower ionic resistance than thicker membranes. Reporting the stress and elongation at break is a universal method for characterizing intrinsic polymer mechanical properties. These measurements can be performed with a dynamic mechanical analyzer (DMA) or a tensile tester. AEM mechanical properties are highly dependent on hydration state and temperature and these environmental conditions can be altered to observe relevant impacts.

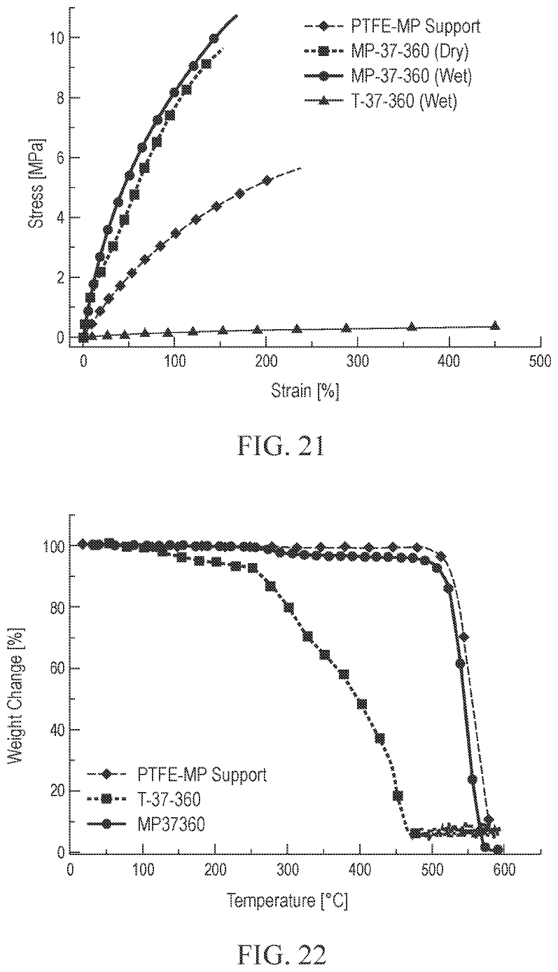

The mechanical properties of the composites were analyzed using a DMA. Under constant force mode on a TA Instruments DMA Q800, the polymers or composites were stretched at 1 N/min until they broke, or the instrument reached maximum displacement. The T-37-360 polymer was viscoelastic, while the PTFE-MP support was more tough (FIG. 21). The MP-37-360 composite was more tough than the support, however did not show any significant difference based on hydration level. The dry MP-37-360 composite had the same response as the wet (room temperature hydration). This indicates that the structural stability of the MP-37-360 composites was not compromised via swelling due to hydration.

Evaluation of Thermal Properties of Composites.

The thermal characteristics of the composites were also considered using differential scanning calorimetry (DSC) and thermal gravimetric analysis (TGA). The DSC analysis showed a thermal transition at 116° C., apparent in both the T-37-360 polymer and the MP-37-360 composite. The DSC trace for T-37-360 and MP-37-360 are provided in FIG. 22. No thermal transitions were observed in the PTFE support. The TGA analysis showed no decomposition until ˜500° C. for the PTFE support, however several transitions were observed for T-37-360 (FIG. 22). A small transition was observed in the MP-37-360 composite around 150° C. A larger transition at ˜260° C. corresponds to significant decomposition in the polymer. Since the polymer completely decomposes by 470° C., and the PTFE support decomposes at 490° C., the weight percent of the polymer can be determined to be ˜4.5%. To verify this, composites were prepared, with the pre- and post-soak weight recorded. Via this method the polymer content in the MP-37-360 composite is ˜2%. The discrepancy in these numbers can be attributed to the small amount of polymer mass within the support—the mass difference/composite ranges from 2-3 mg.

Evaluation of Alkaline Stability of Composites.

Alkaline stability studies are used to evaluate the chemical stability of AEMs in conditions that are relevant to operating alkaline electrolyzers or fuel cells and the standard condition is aqueous 1M KOH at 80° C. At least two analytical techniques can be used at each time point to verify stability: 1) Ambient, hydroxide conductivity to assess the functional-cationic properties of membranes and 2) FT-IR to monitor structural changes.

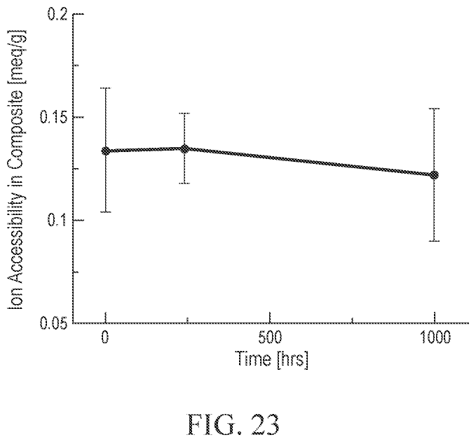

Long-term stability of the MP-37-360 composites was evaluated. This metric is key for potential devices as long-term membrane stability is critical. Previous work has established that Tetrakis® membranes are stable for over 1000 hrs in a variety of harsh conditions (FIG. 10). The MP-37-360 composites were challenged for 1000 hrs at 80° C. in 1 M KOH and ion accessibility was analyzed at several time points. There was no change in the ion accessibility (FIG. 23) indicating that MP-37-360 composites were stable over 1000 hrs.

Fabrication of MEAs and Fuel Cell Testing Results.

After fully characterizing the ex-situ properties of MP-37-360 composites, their performance was analyzed in membrane electrode assemblies (MEAs). The MP-37-360 composites were coated with catalyst/ionomer in an area of 1 cm² to form catalyst coated membranes (CCM). The catalyst ink solution was prepared using water, n-propanol, Tetrakis® ionomer and platinum black. The catalyst ink solution was prepared using water, n-propanol, Tetrakis® ionomer and platinum black. The ratios of solvent, ionomer and catalyst are all critical to reach good device performance. The CCM was sandwiched between two gas diffusion layers (GDLs, AvCarb 280) at a 90% compression level controlled by Teflon gaskets, and clamped between two graphite blocks with serpentine flow fields. These MEAs were symmetric—both the anode and the cathode had the same amount and type of ink applied. Two different ink formulations were considered: one containing 0.12% ionomer (Test 1) and one with 0.05% ionomer (Test 2). Carbon dioxide free air and pure hydrogen were flowed across the cathode and anode at a rate of 50-200 cm³/min, respectively, and the gas flow, voltage and current were controlled via a PEM Technologies test station. The voltage was systematically stepped from the open circuit voltage (˜0.8 V) to 0.1 V, allowing the cell to equilibrate between steps. The cell temperature was increased as desired using the pad heaters attached to the outer metal case for the MEA.

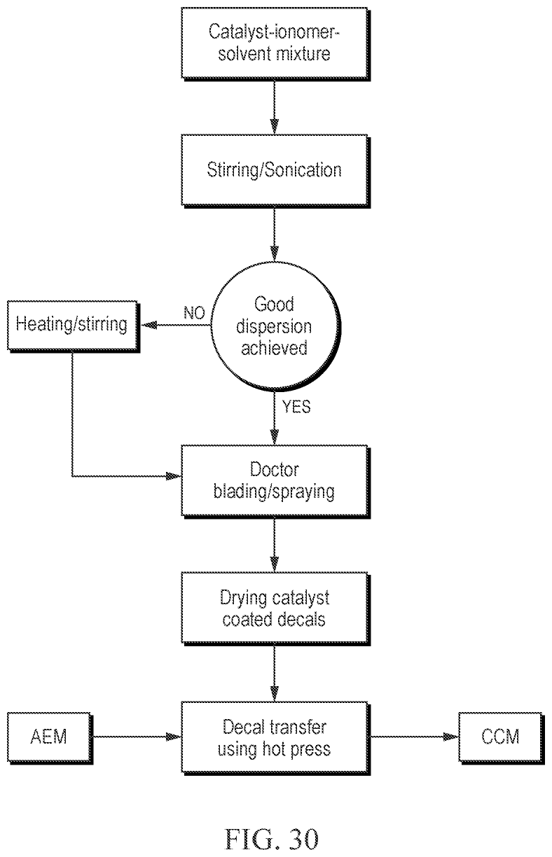

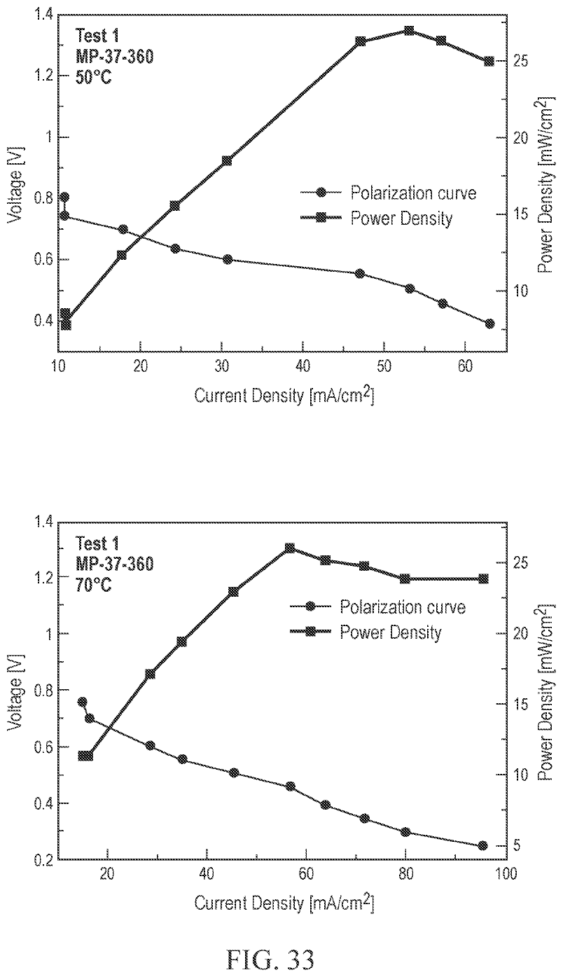

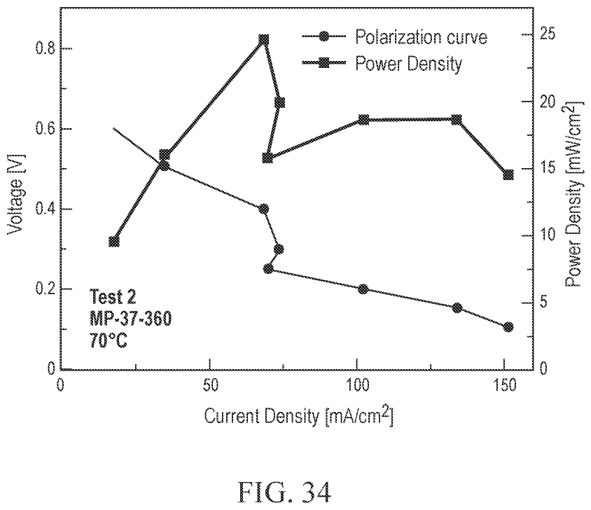

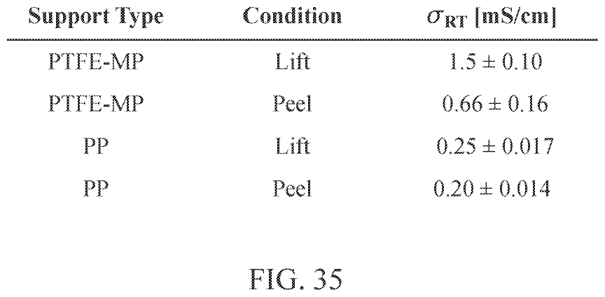

For Test 1, the cell was heated to 50° C. and the voltage stepped as described to get a polarization curve (voltage vs current) that shows a maximum current of 65 mA/cm² with primarily ohmic behavior (FIG. 33, top). The ionomer loading in the CCM was 0.12%. The activation region (increased slope change at high voltage) and mass transport region (increased slope change at low voltage) are not visible. This MEA was then challenged to a short-term durability study of 17 hours at 50° C. with constant gas flow at both electrodes (50 cm³/min). Over the first two hours, the current density decreases, however this is most likely due to limited water access to the membrane (FIG. 32). Water is a reagent at the cathode in an AEM fuel cell, therefore limited water will decrease the overall performance. After the durability test the temperature was increased to 70° C. and a similar polarization curve was obtained by stepping the voltage (FIG. 30, bottom). The maximum current density was ˜100 mA/cm2. The temperature was increased to 80° C. and the cell was able to reach a maximum current density of 520 mA/cm2; however, the cell did not maintain current density beyond a few minutes. The second MEA, designated Test 2, had an CCM with ionomer loading of 0.05% and was analyzed in a similar manner. The polarization curve at 70° C. shows an increase in current density to 150 mA/cm² (FIG. 34). This significant increase in current density indicates the ink formulation is critical to the function of the MEAs.

Composites with PE and PP Supports.

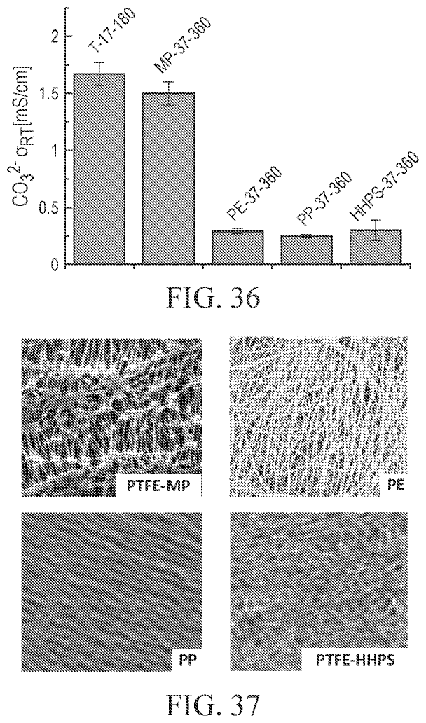

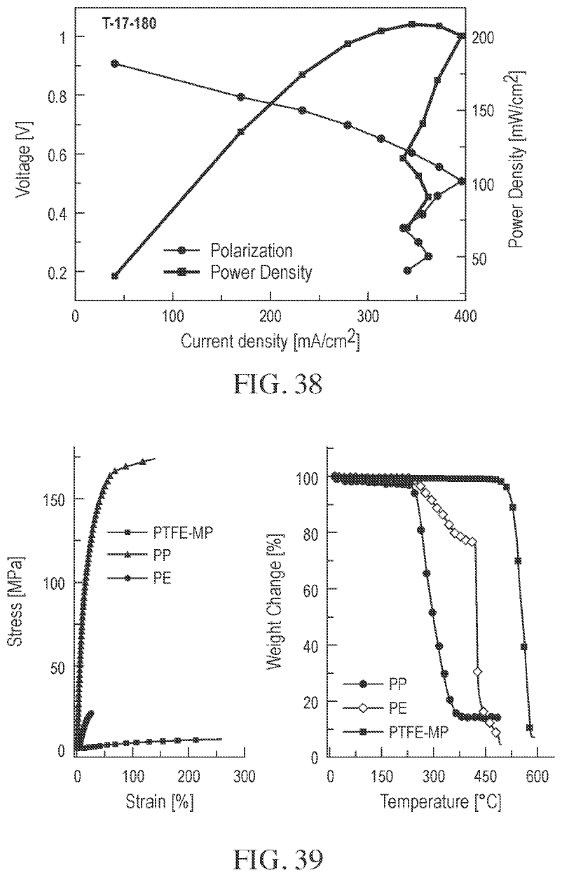

Commercially available supports PE, PP and PTFE were introduced into the composites, and unexpectedly low ionic conductivity of composites prepared with PE and PP supports (FIG. 36). It was originally proposed that a polyolefin support, matching Tetrakis® polymer backbone, would be preferential to a perfluorinated support, like the PTFE support from Millipore Sigma. However, this was not the case. Composites made with polyethylene, PE-37-360 and a composite made with polypropylene, PP-37-360, had ˜90% lower carbonate conductivity. A PTFE support from a different supplier, HHPS-37-360, was evaluated and even though the support has the same chemical composition as MP-37-360, a much lower conductivity was observed. As summarized FIG. 12, these supports had very different characteristics (i.e. pore size, porosity, and thickness); yet, no trend could be determined to explain the relationship between support structure and composite performance. SEM analysis of the bare support materials indicated a previously unknown factor—the macroscopic structure of the supports (FIG. 37).

Mechanical strength of the PE, PP, and PTFE support materials using dynamic mechanical analysis in tensile test configuration (FIG. 39, left). The PE and PP supports were significantly stronger compared to the PTFE-MP support. The thermal properties of the bare supports indicate that PTFE-MP has higher thermal stability compared to PE and PP, but all support materials are stable well beyond the operating limits of the intended electrochemical devices (FIG. 39, right).

The data of the present disclosure suggest that the key to developing AEM composites with excellent performance begins with developing porous polymer supports with the right combination of chemical identity and a macrostructure specifically designed for this application. Commercially available supports serve other purposes well; however, they are not optimized to meet the challenging goals for AEM materials. The present data suggest that pore size, porosity and how the polymer strands in a support material are processed have significant impacts.

As shown in FIG. 36, the through-plane carbonate conductivity of MP-37-360 is similar to T-17-180, with increased mechanical strength and decreased swelling for the composites. This conductivity is remarkably high considering that only 4.5% of the composite is active material (% by weight as determined by TGA). It naturally follows that increasing the amount of polymer within the MP-37-360 composite will dramatically increase the conductivity and likely will not reduce the mechanical improvements.

Electrode Fabrication.

A flow chart for a catalyst coated membrane (CCM) fabrication is shown in FIG. 30. A stable catalyst ink dispersion is prepared in a suitable solvent. The electrode is fabricated into a uniform layer containing dry catalyst and ionomer. The typical methods are painting, using a film applicator or draw bar, or spray coating. The membrane electrode assembly (MEA) (electrodes+composite) is assembled with the gaskets, sub gaskets, gas diffusion layer (GDLs) and then tested under relevant operating conditions. The MEA build is typically custom around each specific polymer electrolyte and the work must be developed in-house for rapid iteration through the variables.

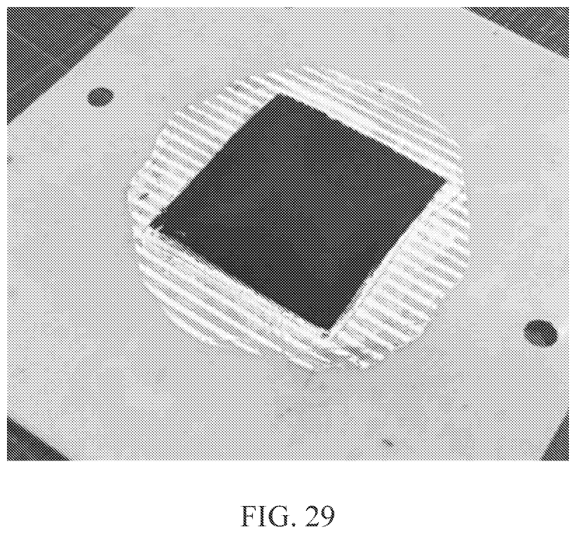

The catalyst ink is ideally a uniform dispersion of catalyst particles and ionomer in an organic solvent/water mixture. An ionomer solution (n-propanol, ethanol or NMP) is diluted further and mixed with catalyst and water. The factors to tune to optimize the catalyst ink include 1) organic solvent 2) ionomer loading 3) catalyst loading 4) water:solvent ratio and 5) dispersion technique (i.e. heating and mixing methods). Importantly, the catalyst ink dispersion should be chemically and physically stable for reproducible results. A catalyst ink for Tetrakis® polymer is shown in FIG. 30 (A). As shown in FIG. 30 (B), the catalyst ink is spread evenly over a Teflon surface to prepare a decal. To prepare a CCM, a piece is cut out for the electrode and it is transferred to the membrane in a method called decal transfer. An example is shown in FIG. 30 (C). Variables that impact electrode generation include temperature, pressure and time of the decal transfer. The particle size distribution of catalyst and ionomer agglomerates in the ink using different solvents will be studied to help achieve a formulation with desired viscosity and surface tension that are critical when using deposition techniques, such as doctor blading with a film applicator. FIG. 29 shows an image of m a catalyst-coated MP-37-360 composite after testing.

Assembling the MEA involves selecting the materials for the gaskets and sub gaskets, which depends on the thickness of the composite. Appropriate gasket sizes should be employed to control the compression of electrodes. Sub-gaskets equal to the size of CCMs can be used to ameliorate membrane creep.

Generating non-platinum electrodes and fabricating MEAs with the newly developed composites is most significant activity to reduce both the materials cost and the switching costs. Platinum is a significant portion of the cost of current commercial devices, which is limiting the adoption rate of these technologies. The ability to use other catalysts is one of the strongest motivations to move towards alkaline electrochemical systems.

Non-platinum electrodes can be used in order to build MEAs with the disclosed composites and alternative catalysts. For example, a performance of 1 A/cm² at 1.9 V with NiFe₂O₄ anode and FeNiCo cathode catalyst in a 5 cm² cell at 60° C. using 1 M KOH has been previously demonstrated. A current density of 1 A/cm2 at 1.9 V can be achieved using NiMo cathode for hydrogen evolution reaction and an iridium black anode in 1 M KOH at 50° C. For alkaline fuel cells, NiMo/KB catalyst (carbon-supported bimetallic nickel-molybdenum) can be used for the hydrogen oxidation reaction, and power density as high as 120 mW/cm² at 0.5 V can be reached under H₂/O₂ operating conditions.

Measuring MEA Performance.

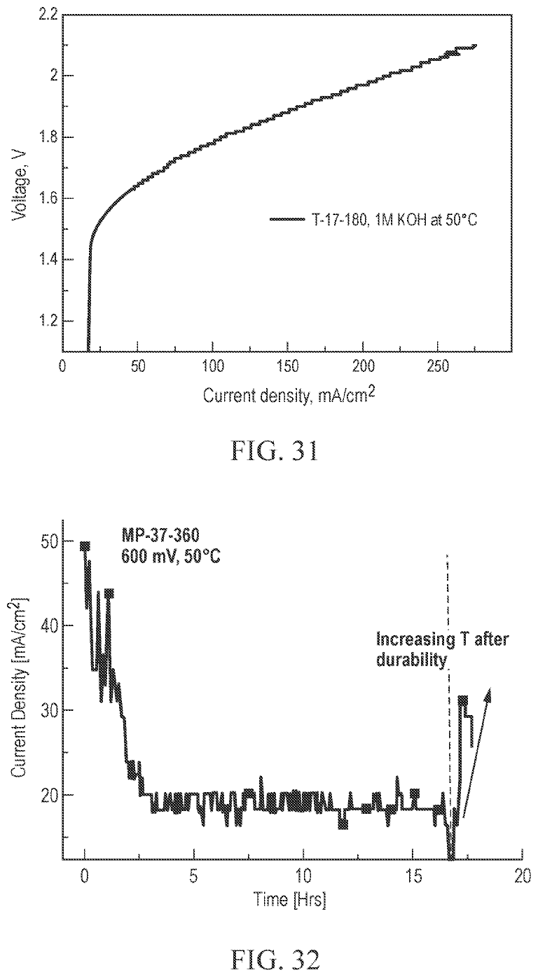

The in-situ electrochemical performance of the MEAs can be evaluated for alkaline fuel cells and electrolysis. Prior to AEMFC performance evaluation, hydrogen crossover during MEA operation can be electrochemically evaluated on fully humidified H₂ and air at ambient pressure and temperature. Open circuit voltage can be evaluated under standard operation conditions for AEMFC and AEME (Alkaline Exchange Membrane Fuel Cell and Alkaline Exchange Membrane Electrolyzers) (humidified H₂ and 02, and aqueous KOH, respectively) and then an I-V curve can be collected by sweeping the potential from OCV to 0.1 V for fuel cells and to 2.1V for electrolyzers. The maximum current density is recorded at key values (0.65V for fuel cells and 1.8 and 2.1V for electrolyzers). Example performance data for the T-17-80 unsupported AEM is provided in FIG. 31.

Additional Cationic Polyelectrolytes

In alternative embodiments, the composite materials of the present invention can employ alkyl ammonium ionomers (polyelectrolytes) as described in U.S. Pat. No. 9,493,397, incorporated herein by reference. Specifically, in one aspect, the present invention provides ionomers having Structure I:

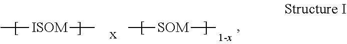

where a first unit is derived from an ionic strained olefin ring monomer (an ISOM unit) and a second unit is derived from a strained olefin ring monomer which does not have an ionic moiety (a SOM unit). The ionomers are random copolymers comprising ISOM units and SOM units or ISOM units and ISOM units. In one embodiment, the ionomer comprises a predetermined number of tetraalkylammonium moieties and the tetraalkylammonium moieties are in predetermined positions.

In one embodiment, adjacent ISOM and SOM units or ISOM and ISOM or SOM and SOM units are connected by a carbon-carbon single bond or a carbon-carbon double bond. The ISOM unit is a hydrocarbon repeat unit comprising at least one alkyl tetraalkylammonium moieties. If there is a carbon atom in the beta position relative to the ammonium nitrogen then the carbon atom does not have a hydrogen substituent. The SOM unit is a hydrocarbon repeat unit. The value of x can be from 0.05 to 1, including all values to the 0.01 and ranges therebetween. The ionomer comprises a predetermined number of ionic moieties and the at least one alkyl tetraalkylammonium moiety is in a predetermined position.

The number averaged molecular weight of the ionomer, Mn, is from 5,000 to 2,000,000, including all integers and ranges therebetween. The ionomer of claim 1, wherein the weight averaged molecular weight of the ionomer, Mw, is from 5,000 to 2,000,000, including all integers and ranges therebetween. The Mn or Mw of the ionomer can be determined by routine methods such as, for example, gel permeation chromatography.

In one embodiment, the end groups of the ionomer are ═CH₂, ═CHR (where R can be CH₂W where W is halide, hydroxide or acetate), ═CHPh, —CH₃, —CH₂R (where R can be CH₂W where W is halide, hydroxide or acetate) and —CH₂Ph.

The tetralkylammonium cations in the ionomers of the present invention can have any anion (A⁻). Examples of suitable anions include any halide, hydroxide, hexafluorophosphate, borate, carbonate, bicarbonate and carboxylate, and the like.

In the structures below R¹, R², R³, and R⁴ are C₁ to C₂₀ groups. The C₁ to C₂₀ groups have from 1 to 20 carbons, including all integers therebetween, and include groups such as, for example, linear or branched alkyl groups (which can be substituted), cyclic alkyl groups (which can be saturated, unsaturated or aromatic), alkyl cyclic alkyl groups (which can be saturated, unsaturated or aromatic), and the like. Examples of C₁ to C₂₀ groups are shown in the following structures (where a wavy line indicates a point of attachment):

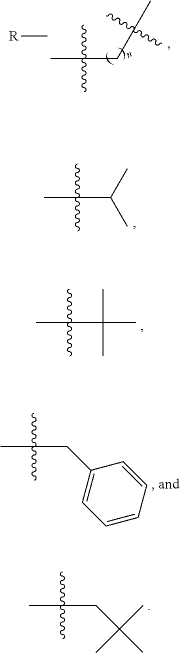

where n is from 0 to 20. For R¹, R², R³, if the C₁ to C₂₀ group has a beta carbon relative to an ammonium nitrogen then the beta carbon of the C₁ to C₂₀ group relative to the ammonium nitrogen does not have a hydrogen substituent. The ionomers can be crosslinked or not crosslinked. In one embodiment, the ionomers are not cross-linked. An example of an unsaturated non-crosslinked ionomer is shown in Structure II:

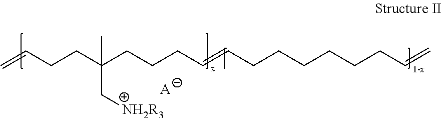

where n is from 1 to 20. An example of a saturated non-crosslinked ionomer is shown in Structure III:

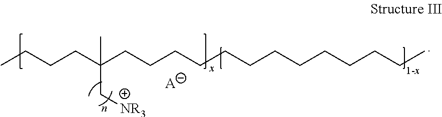

where n is from 1 to 20. For example, the values of x for ionomers of this embodiment include 0.29 or 0.33. The ionomers can be crosslinked or not crosslinked. In one embodiment, the ionomers are not cross-linked.

In another embodiment, the ionomers are crosslinked. In one embodiment, at least one first ISOM or SOM unit is connected by a polyatomic linking group (PAL) comprising a C₁ to C₂₀ group, and if the C₁ to C₂₀ group has a carbon in the beta position relative to the ammonium nitrogen atom then the beta carbon of the C₁ to C₂₀ group does not have a hydrogen substituent, to a second ISOM or SOM unit. The second ISOM or SOM unit can be in the same ionomer chain as the first ISOM or SOM unit or the second ISOM or SOM unit is a different ionomer chain than the first ISOM or SOM unit. For example, the crosslinks between the SOM units are derived from polymerization of a monomer having multiple polymerizable alkene functional groups. An example of an unsaturated SOM crosslinked ionomer is shown in the Structure IV:

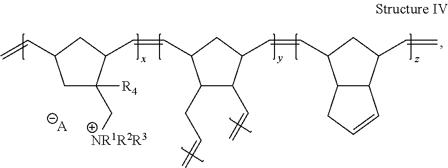

where R⁴ is a C₁ to C₂₀ group (as described above for R¹, R² and R³). The ionomer is crosslinked by carbon-carbon double bonds between a y unit (SOM) a second y unit in the same or different ionomer chain. The value of x is from 0.05 to 1, including all values to 0.01 and ranges therebetween, and x+y+z=1. For example, the values of x for ionomers of Structure IV include 0.33 or 0.5. An example of a saturated SOM crosslinked ionomer is shown in Structure V:

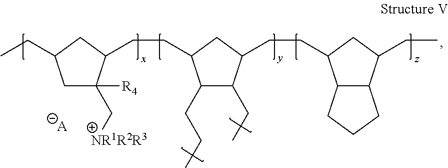

where R⁴ is a C₁ to C₂₀ group (as described above for R¹, R² and R³). The ionomer is crosslinked by carbon-carbon single bonds between a y unit (SOM) a second y unit in the same or different ionomer chain. The value of x is from 0.05 to 1, including all values to 0.01 and ranges therebetween, and x+y+z=1. In these two examples the SOM block is derived from dicyclopentadiene, which has multiple polymerizable alkene functional groups. For example, the values of x for ionomers of Structure V include 0.33 or 0.5

In another embodiment, the ionomers are crosslinked, where the crosslinks are derived from a multi-functional monomer having two ISOM moieties joined by a polyatomic linking group (PAL), and have, for example, Structures VI or VII:

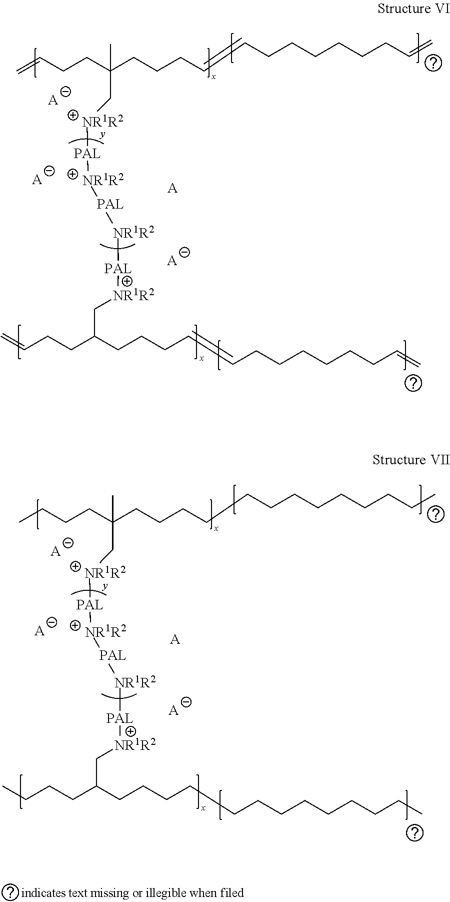

where each PAL, independently, comprises a C₁ to C₂₀ group (as described above for R¹, R² and R³). The value of y is from 0 to 20, including all integers and ranges therebetween. Examples of an unsaturated (Structure VIII) and saturated (Structure IX) ionomer where the crosslinks are derived from a multi-functional monomer having two ISOM moieties joined by a polyatomic linking group (PAL) is shown in the following structures:

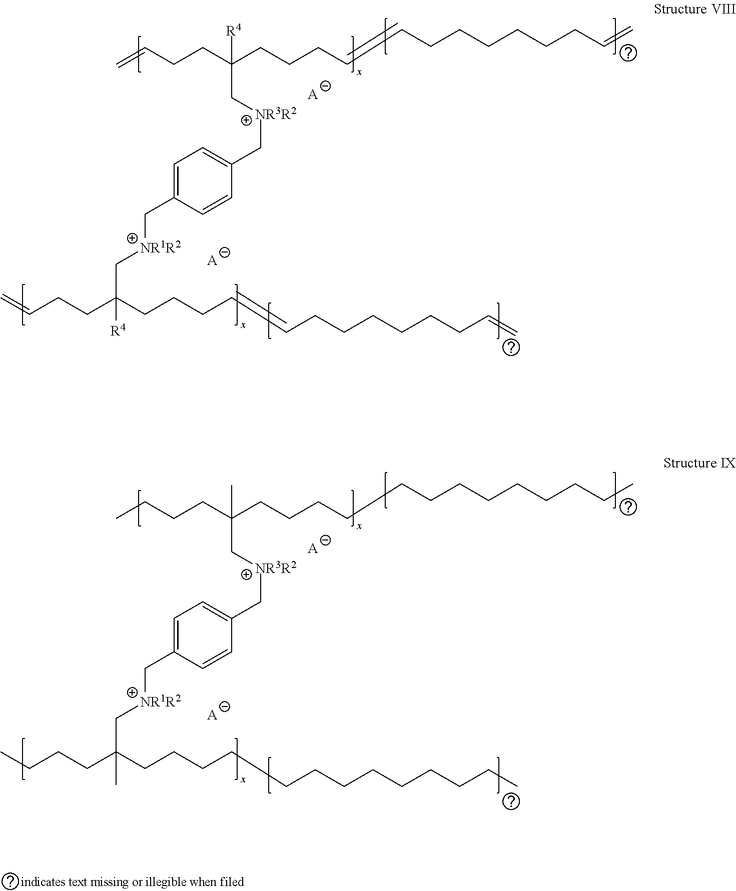

For example, the values of x for ionomers of Structure VIII and IX include 0.25, 0.29, 0.33, 0.40 and 0.50.

In another aspect, the present invention provides compounds comprising at least one alkyl tetraalkylammonium group, which can be used as monomers from which an ISOM unit can be derived. In one embodiment, the compound has the following structure:

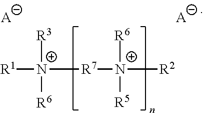

In this embodiment, R¹ is a C₄ to C₂₀ cycloalkenyl group, such as, for example, a cyclooctene, norbornene, cyclooctadienene, and the like. R², R³, R⁴, R⁵, R⁶ and R⁷ are each, independently, a C₁ to C₂₀ group. For each of these groups having a carbon in the beta position relative to the ammonium nitrogen, the beta carbon does not have a hydrogen substituent. In one embodiment, R² is C₄ to C₂₀ cycloalkenyl group, such as, for example, a cyclooctene, norbornene, cyclooctadienene and the like, and the carbon in the beta position relative to the ammonium nitrogen does not have a hydrogen substituent. The value of n is from 0 to 20, including all integers and ranges therebetween. A⁻ is any halide, hydroxide, hexafluorophosphate, any borate, any carbonate, any bicarbonate or any carboxylate.

In one embodiment, the monomer has one of the following structures:

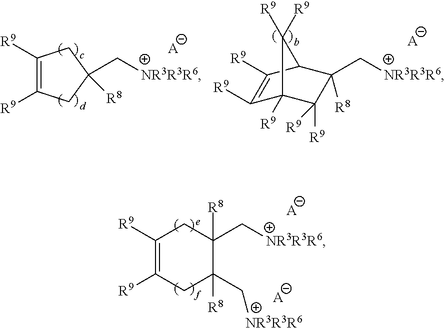

R², R³, R⁶ and R⁸ are each, independently, a C₁ to C₂₀ group, wherein if the C₁ to C₂₀ group has a beta carbon then the beta carbon of the C₁ to C₂₀ group does not have a hydrogen substituent. Each R⁹ is independently a H or C₁ to C₂₀ group. The values of c and d are, independently, from 0 to 5, including all integers therebetween. The value of b is 1 or 2. The values of e and f are each, independently, from 0 to 4, including all integers therebetween.

In one embodiment, the compound has one of the following structures:

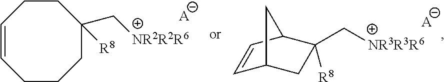

R², R³, R⁶ and R⁸ are each, independently, a C₁ to C₂₀ group, wherein if the C₁ to C₁₀ group has a beta carbon then the beta carbon of the C₁ to C₂₀ group does not have a hydrogen substituent.

In one embodiment, the present invention provides a multifunctional monomer (MFM) which has at least two ISOM moieties. These two moieties are joined by a polyatomic linking group (PAL). The MFM can have Structure X:

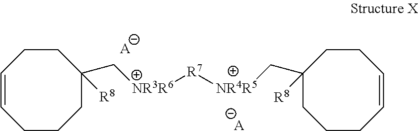

The PAL (R⁷) is a hydrocarbon group comprising from 1 to 20 carbons, including all integers and ranges therebetween, and that connects two ammonium groups. Examples of a PAL group include groups such as, for example, linear or branched alkyl groups (which can be substituted), cyclic alkyl groups (which can be saturated, unsaturated or aromatic), alkyl cyclic alkyl groups (which can be saturated, unsaturated or aromatic), and the like. In one embodiment, R⁷ has the following structure (where a wavy line indicates a point of attachment):

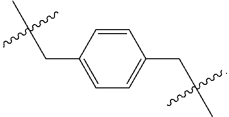 [SMILES: *Cc1ccc(C*)cc1]

In one embodiment, the MFM has the following structure:

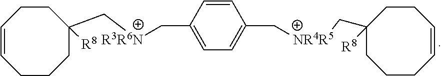

In one embodiment, the present invention provides ionomers synthesized by polymerization of the compounds described above. For example, a homopolymer of one of the compounds described above from which ISOM units are derived is produced. In another embodiment, the compounds described above and another monomer, which does not have an ionic moiety such as an alkyl tetraalkylammonium group, from which SOM unites are derived are polymerized. For example, a random copolymer of one of the compounds described above and another monomer which does not have an ionic moiety (e.g., a substituted or unsubstituted cyclooctene, norbornene or dicyclopentadiene).

The ionomers comprise ISOM units or ISOM units and SOM units. The ISOM unit is derived from a monomer (ionic strained olefin monomer-ISOM monomer), such as, for example, the compounds of the present invention described above, which has a strained ring structure and both an alkene moiety (moieties) which can be polymerized (e.g., by ring-opening metathesis polymerization) and at least one ionic moiety (e.g., a tetraalkylammonium group). The SOM unit is derived from a monomer (strained olefin monomer—SOM) which has a strained ring structure and an alkene moiety which can be polymerized (e.g., by ring-opening metathesis polymerization), but does not have an ionic moiety.

By strained ring structure it is meant that the molecule is reactive toward ring opening metathesis polymerization due to non-favorable high energy spatial orientations of its atoms, e.g., angle strain results when bond angles between some ring atoms are more acute than the optimal tetrahedral) (109.5° (for sp³ bonds) and trigonal planar (120°) (for sp² bonds) bond angles.

The ionomer has ISOM units and SOM units or ISOM units and ISOM units where adjacent units are connected by a carbon-carbon single bond or a carbon-carbon double bond. For example, an ionomer having ISOM units and SOM units or ISOM units and ISOM units connected by a carbon-carbon double bond can be subjected to reaction conditions such that carbon-carbon double bonds are reduced to carbon-carbon single bonds. In one embodiment, for uncrosslinked ionomer having ISOM units and SOM units or ISOM units and ISOM units connected by carbon-carbon double bonds, 100% of the carbon-carbon double bounds are reduced to carbon-carbon single bonds. In various embodiments, for ionomers having ISOM units and SOM units or ISOM units and ISOM units connected by carbon-carbon double bonds, at least 50%, 75%, 90%, 95%, or 99% or greater than 99% or 100% of the carbon-carbon double bonds in the ionomer are reduced to carbon-carbon single bonds. Without intending to be bound by any particular theory, it is considered that hydrogenation of carbon-carbon double bonds in an ionomer increases the mechanical strength of a film made from the hydrogenated monomer.

The monomer from which a SOM unit is derived (SOM monomer) is a hydrocarbon which has at least one alkene group which can be polymerized. The SOM can have multiple alkene moieties which can result in the ionomer being crosslinked as a result of polymerization of two alkene moieties from two different SOM units. An example of such a SOM is dicyclopentadiene.

In one embodiment, the ROMP synthesis of the ionomers of the present invention is carried out using an SOM monomer selected from the following structures:

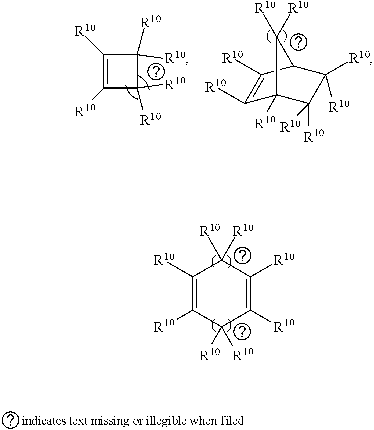

and combinations thereof. Each R¹⁰ is independently selected from H and a C₁ to C₂₀ group (as described herein). The value of h is from 1 to 10, including all integers therebetween. The value of g is 1 or 2. The values of j and k are, independently, from 0 to 5, including all integers therebetween.

In one embodiment, the ROMP synthesis provides polymers which are crosslinked. For example, an ISOM monomer and a monomer with multiple alkene functional groups which can be polymerized such as, for example, DCPD can be copolymerized to provide crosslinked ionomers.

In one embodiment, the ROMP synthesis uses a SOM monomer having one of the following structures providing crosslinked ionomers:

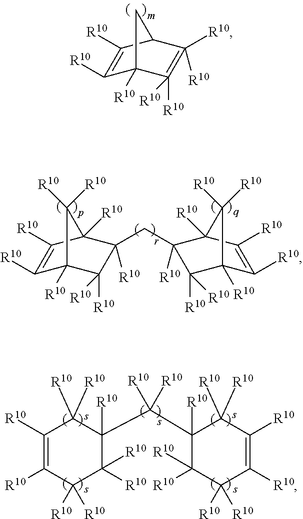

and combinations thereof. Each R¹⁰ is independently selected from H and a C₁ to C₂₀ group (as described herein). The value of m is 1 or 2. The value of p and q are, independently, 1 or 2. The value of n is from 1 to 20, including all integers therebetween. The value of each s is, independently, from 0 to 5.

In one aspect, the present invention provides a method to synthesize ionomer materials. The ionomers can be synthesized by, for example, ring-opening metathesis polymerization (ROMP), which can be carried out using a transition metal (e.g., ruthenium-based) metathesis catalyst (e.g., a second generation Grubbs-type catalyst). The steps of the ROMP polymerization are known in the art. For example, the method includes the steps of providing an ISOM monomer and, optionally, a SOM monomer and a catalyst (such as a ruthenium-based alkene metathesis catalyst). The monomer(s) and catalyst are combined and, optionally, an appropriate solvent is added. The reaction mixture is heated under conditions such that an ionomer is formed.

In one embodiment, an ISOM monomer and a SOM monomer are combined in the presence of a catalyst (e.g., a second generation Grubbs ROMP catalyst) under conditions such that a ring-opening metathesis polymerization reaction takes place forming an ionomer having Structure I-V. The use of air-stable Grubbs'-type catalysts allows functionalized monomers to be polymerized because these catalysts are tolerant of a variety of functional groups. By employing monomers with the tetraalkylammonium moiety already present, membrane synthesis is greatly simplified because postpolymerization modifications are unnecessary.

In another embodiment, a multifunctional monomer (MFM) or a MFM and a SOM monomer are combined in the presence of a catalyst (e.g., a second generation Grubbs ROMP catalyst) under conditions such that a ring-opening metathesis polymerization reaction takes place forming, for example, an ionomer having Structure VI or VII.

It is desirable that the ionomer material have hydroxide anions. Thus, in one embodiment, if the ionomer material does not have hydroxide anions, the ionomer material is subjected to ion exchange conditions such that the non-hydroxide anions are exchanged for hydroxide anions and the resulting ionomer material has hydroxide anions.

In one aspect, the ionomer materials of the present invention can be used in devices such as, for example, fuel cells, hydrogen generators, water purification devices, and the like. In one embodiment, the present invention provides a fuel cell operating under alkaline conditions comprising an alkaline anion exchange membranes (AAEM) comprising an ionomer of Structure I.

Within a fuel cell, the ion exchange membrane serves as the conducting interface between the anode and cathode by transporting the ions while being impermeable to gaseous and liquid fuels. It is desirable that an ion exchange membrane have the four properties listed below.

An ionomer interface material is typically derived from a solvent processable ionomer. Ideally, the solvent processable ionomer should be insoluble in water and methanol or aqueous methanol, but soluble in mixtures of other low boiling point solvents (removal of a high boiling point solvent is considered difficult and unsafe in the presence of finely dispersed catalysts) such as n-propanol or aqueous n-propanol. To form the electrodes, soluble ionomer is combined with an electrocatalyst and “painted” on either a gas diffusion layer (GDL) or the membrane itself. This combination of the ionomer, electrocatalyst and GDL forms the electrode. The ionomer should also have high hydroxide conductivity.

It is desirable that the AAEM comprising the ionomer materials of the present invention have at least the following properties:
(1) low methanol solubility, and it is desirable that the ionomer be completely insoluble in methanol;
(2) hydroxide conductivity of from 1 mS/cm to 300 mS/cm, including all integers and ranges therebetween. In various embodiments, the AAEM has a hydroxide conductivity of at least 1, 5, 10, 25, 50, 100, 150, 200 or 300 mS/cm. The hydroxide conductivity is measured by methods known in the art;
(3) mechanical properties such that a membrane comprising an ionomer of the present invention does not tear or fracture under fuel cell operating conditions. In one embodiment, the membrane does not fail (e.g., tear or fracture) under a tensile stress of 1 to 500 MPa, including all integers and ranges therebetween, at a strain of 5% to 1000%, including all integers and ranges therebetween, under fuel cell operating conditions; and
(4) little swelling/hydrogel formation under alkaline fuel cell conditions. In one embodiment, the swelling is from 0 to 20%, including all integers and ranges therebetween, of original AAEM film thickness. Swelling of the ion exchange membrane increases its resistance thereby decreasing its conductivity, ultimately leading to diminished fuel cell performance. If swelling results in hydrogel formation the membrane will become permeable to gases and cease to operate. As a result, excessive membrane swelling that causes hydrogel formation should be avoided.

In one embodiment, the present invention provides an AAEM comprising an ionomer of the present invention. The AAEM displays the desirable properties set out above. The thickness of the AAEM comprising the ionomer materials of the present invention can be from 1 m to 300 m, including all values to the 1 m and ranges therebetween.

In some embodiments, the present invention provides a water electrolysis cell comprising an alkali anion exchange membrane (AAEM) comprising an ionomer of the present invention. The water electrolysis cell can be used to produce oxygen and hydrogen from water.

In alternative embodiments, the composite materials of the present invention can employ alkyl ammonium ionomers (polyelectrolytes) as described in U.S. Patent Application Publication No. 2019/0047963, incorporated herein by reference. Specifically,

In one aspect, the invention provides a compound of formula (I) or (II):

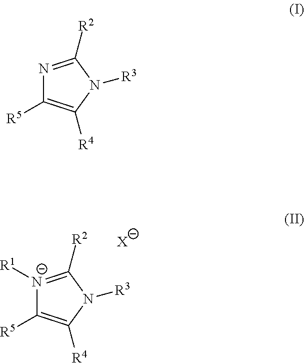

wherein:
R¹ is selected from C₂-C₁₆ hydrocarbyl, wherein one carbon atom of the C₂-C₁₆ hydrocarbyl may optionally be replaced by 0; R² is phenyl substituted with 0 to 3 substituents R⁶ individually selected from C₁-C₃ alkyl; R³ is selected from C₂-C₁₆ hydrocarbyl; R⁴ and R⁵ are individually selected from C₁-C₁₆ hydrocarbyl, or, taken together, R⁴ and R⁵, together with the carbon atoms to which they attached, form a ring selected from benzene, cyclooctene and norbornene; and X— is a counterion.

As shown above, compounds of formula (I) are imidazole compounds (wherein R¹ is not present), and compounds of formula (II) are positively charged imidazolium cations.
R¹ is selected from C₂-C₁₆ hydrocarbyl (i.e., C₂, C₃, C₄, C₅, C₆, C₇, C₈, C₉, C₁₀, C₁₁, C₁₂, C₁₃, C₁₄, C₁₅, or C₁₆ hydrocarbyl), wherein one carbon atom (and hydrogen atoms attached to said carbon atom) of the C₂-C₁₆ hydrocarbyl may optionally be replaced by oxygen (O).

In some embodiments, R¹ is selected from C₂-C₁₆ hydrocarbyl (wherein no carbon atom is replaced by O).

In some embodiments, R¹ is selected from C₂-C₁₆ hydrocarbyl (or any subgroup thereof), wherein one carbon atom, which is not at the point of attachment of R¹ to the nitrogen at position 1 of the imidazole ring, is replaced by O.

In some embodiments, R¹ is selected from C₂-C₁₂ hydrocarbyl, wherein one carbon atom of the C₂-C₁₂ hydrocarbyl may optionally be replaced by O.

In some embodiments, R¹ is selected from C₂-C₁₀ hydrocarbyl, wherein one carbon atom of the C₂-C₁₀ hydrocarbyl may optionally be replaced by O.

In some embodiments, R¹ is selected from C₂-C₇ hydrocarbyl, wherein one carbon atom of the C₂-C₇ hydrocarbyl may optionally be replaced by O.

In some embodiments, R¹ is selected from C₂-C₄ hydrocarbyl, wherein one carbon atom of the C₂-C₄ hydrocarbyl may optionally be replaced by O.

In some embodiments, R¹ is selected from C₂-C₈ alkyl, wherein one carbon atom of the C₂-C₈ alkyl may optionally be replaced by O.

In some embodiments, R¹ is selected from C₂-C₆ alkyl, wherein one carbon atom of the C₂-C₆ alkyl may optionally be replaced by O.

In some embodiments, R¹ is selected from ethyl, n-propyl, isopropyl, n-butyl, isobutyl, sec-butyl, tert-butyl, n-pentyl, isopentyl, neopentyl, and hexyl, wherein one carbon atom may optionally be replaced by O.

In some embodiments, R¹ is an alkylaralkyl group, wherein one carbon atom of the alkylaralkyl group may optionally be replaced by O. For example, in some embodiments, R¹ is H(CH₂)p-(Ph)q-(CH₂)r-*, wherein: * represents the point of attachment to the nitrogen at position 1 of the imidazole; p is 1-6; q is 0 or 1; and r is 1-6, provided that the total number of carbon atoms in R¹ is 2-16, and wherein one carbon atom may optionally be replaced by O. As used herein, the abbreviation “Ph” represents phenyl.

In some embodiments, R¹ is H(CH₂)p-(Ph)q-(CH₂)r-*, wherein: * represents the point of attachment to the nitrogen at position 1 of the imidazole; p is 1-6; q is 0 or 1; and r is 1-6, provided that the total number of carbon atoms in R¹ is 2-16, and wherein one carbon atom of the (CH₂)p may optionally be replaced by O.

In some embodiments, R¹ is:

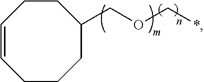

wherein: * represents the point of attachment to the nitrogen atom at position 1 of the imidazolium ring; m is 0 or 1; and n is 1-8, provided that the sum of m+n does not exceed 8. These embodiments (and other embodiments having other strained cyclo olefin rings in R¹) find particular use in Ring Opening Metathesis Polymerization (ROMP), which, as discussed below, is one technique that can be used to incorporate imidazolium cations in polymers.

In some embodiments, R¹ is benzyl.

In some embodiments, R¹ is not benzyl.

R² is phenyl substituted with 0 to 3 substituents R⁶ (i.e., substituted with R⁶ 0, 1, 2, or 3 times). Each R⁶ (if present) is individually selected from C₁-C₃ alkyl.

The applicant has discovered that imidazolium cation compounds comprising a phenyl group at R² are more base-stable than those with alkyl groups. This observation contrasts with trends observed by Lin et al., Chem. Mater., 25, 1858 (2013), where alkyl substituents improved stability compared to phenyl groups.

In some embodiments, R² is unsubstituted phenyl.

In some embodiments R² is substituted with R⁶ 1-3 times, and each R⁶ is individually selected from methyl, ethyl, n-propyl, and isopropyl.

In some embodiments R² is a moiety of formula (R^{2a}):

wherein: represents the point of attachment to the imidazole or imidazolium ring; and R^{6a}, R^{6b}, and R^{6c} are individually selected from hydrogen and C₁-C₃ alkyl.

In some embodiments, at least two of R⁶, R^{6b}, and R^{6c} are individually selected from methyl and isopropyl.

R³ is selected from C₂-C₁₆ hydrocarbyl (i.e., C₂, C₃, C₄, C₅, C₆, C₇, C₈, C₉, C₁₀, C₁₁, C₁₂, C₁₃, C₁₄, C₁₅, or C₁₆ hydrocarbyl).

In some embodiments, R³ is selected from C₂-C₁₂ hydrocarbyl.

In some embodiments, R³ is selected from C₂-C₁₀ hydrocarbyl.

In some embodiments, R³ is selected from C₂-C₇ hydrocarbyl.

In some embodiments, R³ is selected from C₂-C₄ hydrocarbyl.

In some embodiments, R³ is selected from C₂-C₈ alkyl.

In some embodiments, R³ is selected from C₂-C₆ alkyl.

In some embodiments, R³ is selected from ethyl, n-propyl, isopropyl, n-butyl, isobutyl, sec-butyl, tert-butyl, n-pentyl, isopentyl, neopentyl, and hexyl.

In some embodiments, R³ is benzyl.

In some embodiments, R³ is not benzyl.

R⁴ and R⁵ are individually selected from C₁-C₁₆ hydrocarbyl, or, taken together, R⁴ and R⁵, together with the carbon atoms to which they attached, form a ring selected from benzene, cyclooctene and norbornene.

In some embodiments, R⁴ and R⁵ are individually selected from C₁-C₁₂ hydrocarbyl. In some embodiments, R⁴ and R⁵ are individually selected from C₁-C₁₀ hydrocarbyl.

In some embodiments, R⁴ and R⁵ are individually selected from C₁-C₇ hydrocarbyl.

In some embodiments, R⁴ and R⁵ are individually selected from C₁-C₄ hydrocarbyl.

In some embodiments, R⁴ and R⁵ are individually selected from C₁-C₅ alkyl.

In some embodiments, R⁴ and R⁵ are individually selected from C₁-C₆ alkyl.

In some embodiments, R⁴ and R⁵ are individually selected from methyl, ethyl, n-propyl, isopropyl, n-butyl, isobutyl, sec-butyl, tert-butyl, n-pentyl, isopentyl, neopentyl, and hexyl.

In some embodiments, R⁴ and R⁵ are individually selected from C₁-C₆ alkyl and phenyl optionally substituted with C₁-C₃ alkyl.

X— is a counterion.

In some embodiments, X— is selected from hydroxide, halide, bicarbonate, carbonate, nitrate, cyanide, carboxylate and alkoxide.

In particular embodiments, X— is hydroxide.

In some embodiments, X— is halide selected from fluoride (F⁻), chloride (Cl⁻), bromide (Br⁻), and iodide (I⁻).

In some embodiments, the total number of carbon atoms in R¹-R⁶ is 10-greater than or equal to 10.

In some embodiments, the total number of carbon atoms in R¹-R⁶ is 10-60, (i.e., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 carbon atoms) including any and all ranges and subranges therein (e.g., 10-50, 15-45, 18-45, etc.).

In some embodiments, the invention provides a compound of formula (I), wherein R³ is selected from C₂-C₁₂ hydrocarbyl, or of formula (II), wherein R¹ and R³ are independently selected from C₂-C₁₂ hydrocarbyl.

In some embodiments, the invention provides a compound of formula (I), wherein R³ is selected from C₂-C₇ hydrocarbyl, or of formula (II), wherein R¹ and R³ are independently selected from C₂-C₇ hydrocarbyl.

In some embodiments, the invention provides a compound of formula (I), wherein R³ is selected from C₂-C₄ alkyl and benzyl, or of formula (II), wherein R¹ and R³ are independently selected from C₂-C₄ alkyl and benzyl.

In some embodiments, the invention provides a compound wherein R⁴ and R⁵ are individually selected from phenyl and C₁₋₃ alkyl.

In some embodiments, the invention provides a compound wherein R² is the moiety R^{2a} shown above, and the compound is:
of formula (I), wherein: R³ is n-butyl; R^{6a} and R^{6b} are methyl, and R^{6b} is hydrogen; and R⁴ and R⁵ are individually selected from phenyl and methyl; or
of formula (II), wherein: R¹ and R³ are each n-butyl; R^{6a} and R^{6b} are methyl, and R^{6b} is hydrogen; and R⁴ and R⁵ are individually selected from phenyl and methyl.

In some embodiments, the invention provides a compound of formula (II), said compound being a monomer, e.g., of the formula (IIA), (IIB), or (IIC):

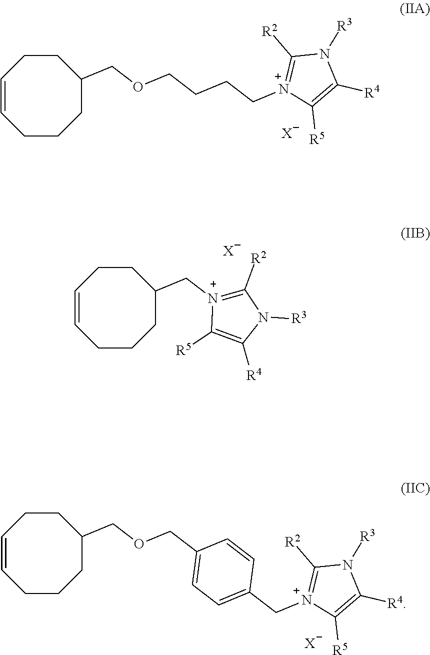

In some embodiments, the invention provides compounds having improved alkaline stability. As discussed above, imidazole compounds and/or imidazolium cations (and polymers containing such compounds) that are stable under basic conditions are extremely important for various applications.

In some embodiments, the invention provides a compound having an alkaline stability of between 75% and 100% cation remaining after 30 days in 5M KOH/CD₃OH at 80° C., including any and all ranges and subranges therein (e.g., between 80% and 100%, between 85% and 100%, between 90% and 100%, between 95% and 100%, etc.). Said stability is determined by preparing solutions of the cation in basified methanol-d₃ (KOH/CD₃OH) and stored in flame-sealed NMR tubes at 80° C. At uniform time intervals, the solutions are analyzed by 1^{H} NMR spectroscopy for amount of cation remaining relative to an internal standard. The use of CD₃OH precludes a hydrogen/deuterium exchange process that causes a reduction in the cation signals (not related to degradation) and obscures new product signals. Key aspects of cation degradation routes were revealed with this new protocol, which facilitates the design of new imidazoliums with strategically placed substituents to prevent decomposition.

In some embodiments, the invention provides a compound having an alkaline stability of greater than or equal to 80% cation remaining after 30 days in 5M KOH/CD3OH at 80° C. (e.g., greater than or equal to 80, 81, 82, 83, 84, 85, 86, 87, 88, 89, 90, 91, 92, 93, 94, 95, 96, 97, 98, or 99%).

In some embodiments, the invention provides a compound of formula (I):

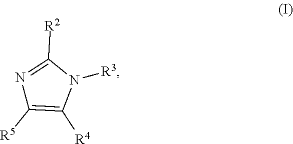

with R²-R⁶ and X— being defined as discussed above.

As discussed below, compounds of formula (I) are useful as intermediates in the preparation of polymers according to a second aspect of the invention (discussed below).

In some embodiments, the invention provides a compound of formula (II):

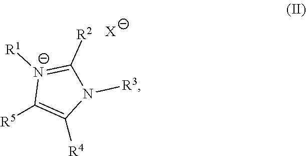

with R¹-R⁶ and X— being defined as discussed above.

In addition to being useful when residues thereof are incorporated into polymers according to a second aspect of the invention (discussed below), compounds of formula (II) are also useful as predictive tools for assessing the stability of polymers according to the second aspect of the invention, and for various other applications, such as organocatalysts, solar cell electrolytes, phase transfer catalysts, and as carbon material precursors.

Imidazole compounds of formula (I) are a class of organic compounds that are readily amenable to synthesis because they can be prepared by a modular route, with easily modified substituents, and they are readily converted to imidazolium cations (e.g., of formula (II) via alkylation.

Methods of synthesizing imidazole and imidazolium compounds are well known in the art. In some embodiments, compounds of formula (I) or formula (II) are synthesized as shown below in Scheme 1:

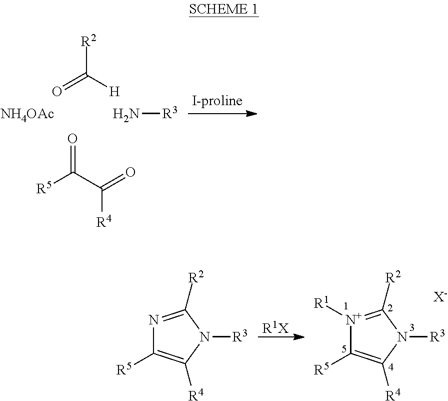

In a second aspect, the invention provides a polymer comprising a plurality of imidazolium-containing repeating units (IRUs) of formula (III′):

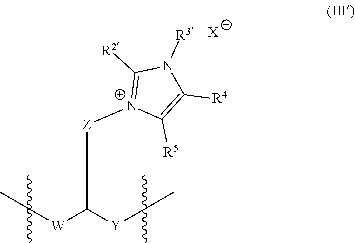

wherein:
R^{2′} is selected from C₁-C₆ alkyl and R²; R² is phenyl substituted with 0 to 3 substituents R⁶ individually selected from C₁-C₃ alkyl;
R^{3′} is selected from hydrogen, methyl, and R³; R³ is selected from C₂-C₁₆ hydrocarbyl;
R⁴ and R⁵ are individually selected from C₁-C₁₆ hydrocarbyl, or, taken together, R⁴ and R¹, together with the carbon atoms to which they attached, form a ring selected from benzene, cyclooctene and norbornene;
X— is a counterion;
wavy lines indicate points of attachment to adjacent repeating units of the polymer;
W is a direct bond or C₁-C₁₀ hydrocarbyl;
Y is a direct bond or C₁-C₁₀ hydrocarbyl; and
Z is a direct bond or C₁-C₁₃ hydrocarbyl, wherein one carbon atom of the C₁-C₁₃ hydrocarbyl may optionally be replaced by O, provided that the sum of carbon atoms in
W, Y, and Z is 1-15.

The polymers described herein contain imidazolium moieties. The polymers are desirable for use as, inter alia, alkaline anion exchange membranes (AAEMs) because their imidazolium cations provide enhanced stability under fuel cell operating conditions, as compared to other (e.g., ammonium) cations, which degrade rapidly under fuel cell operating conditions, limiting their utility and making the improvement of AAEM stability a critical priority. The fuel cells are constructed by methods well known in the art in which the membrane described herein can replace the anion exchange membrane of the art.

For polymers according to the second aspect of the invention, R²-R⁶ are as defined above with respect to the various embodiments of the first aspect of the invention.

W is a direct bond or C₁-C₁₀ hydrocarbyl.

In some embodiments, W is a direct bond or (C₁-C₁₀)alkylene (i.e., C₁, C₂, C₃, C₄, C₅, C₆, C₇, C₈, C₉, or C₁₀ alkylene).

Y is a direct bond or C₁-C₁₀ hydrocarbyl.

In some embodiments, Y is a direct bond or (C₁-C₁₀)alkylene (i.e., C₁, C₂, C₃, C₄, C₅, C₆, C₇, C₈, C₉, or C₁₀ alkylene).

In some embodiments, W is (CH₂)₁₋₅ and Y is (CH₂)₁₋₅.

Z is a direct bond or C₁-C₁₃ hydrocarbyl, wherein one carbon atom of the C₁-C₁₃ hydrocarbyl may optionally be replaced by O.

In some embodiments Z comprises a phenylene moiety. Phenylene refers to a bivalent phenyl:

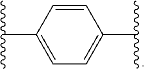 [SMILES: *c1ccc(*)cc1]

In some embodiments, the inventive polymers comprise a compound according to formula (I) or (II), or a residue thereof.

In some embodiments, the inventive polymer of formula (III′) is a polymer according to formula (III):

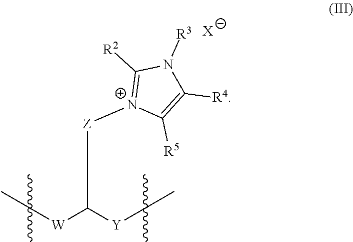

In some embodiments, the inventive polymer comprises a plurality of imidazolium-containing repeating units of formula (IIIA′): wherein: m is 0 or 1; and Z^{1a} is C₁-C₁₃ hydrocarbyl.

In some embodiments, the inventive polymer comprises imidazolium-containing repeating units of formula (IIIA):

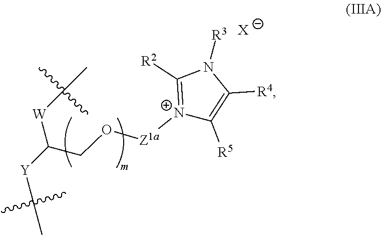

wherein: m is 0 or 1; and Z^{1a} is C₁-C₁₃ hydrocarbyl.

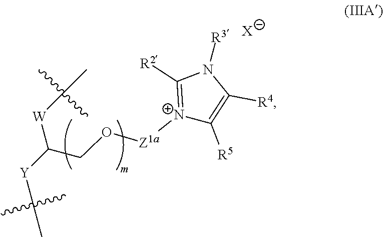

wherein: m is 0 or 1; and Z^{1a} is C₁-C₁₃ hydrocarbyl.

In some embodiments of polymers comprising imidazolium-containing repeating units of formula (IIIA′) or (IIIA), m is 0.

In some embodiments of polymers comprising imidazolium-containing repeating units of formula (IIIA′) or (IIIA), m is 1.

In some embodiments of polymers comprising imidazolium-containing repeating units of formula (IIIA′) or (IIIA), Z^{1a} is C₁-C₁₀ hydrocarbyl.

In some embodiments of polymers comprising imidazolium-containing repeating units of formula (IIIA′) or (IIIA), Z^{1a} is C₁-C₈ hydrocarbyl.

In some embodiments of polymers comprising imidazolium-containing repeating units of formula (IIIA′) or (IIIA), Z^{1a} is —(CH₂)ₚ—(Ph)_{q}-(CH₂)ᵣ—, wherein: p is 1-6; q is 0 or 1; and r is 1-6. In some embodiments, p is 1-2; q is 0 or 1; and r is 1-2.

In some embodiments, the inventive polymer comprises imidazolium-containing repeating units of formula (IIIB′):

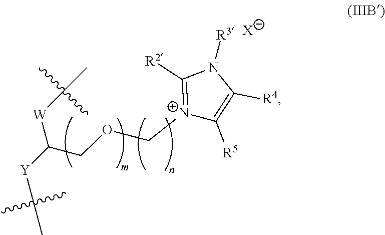

wherein:
m is 0 or 1; and
n is 1-8.

In some embodiments, the inventive polymer comprises imidazolium-containing repeating units of formula (IIIB):

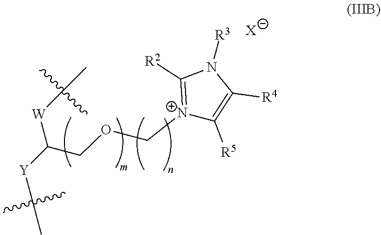

wherein:
m is 0 or 1; and
n is 1-8.

In some embodiments, the polymer comprises a polyolefin or polystyrene backbone.

In some embodiments, the inventive polymer comprises imidazolium-containing repeating units of formula (IIIC′) or (IIIC):

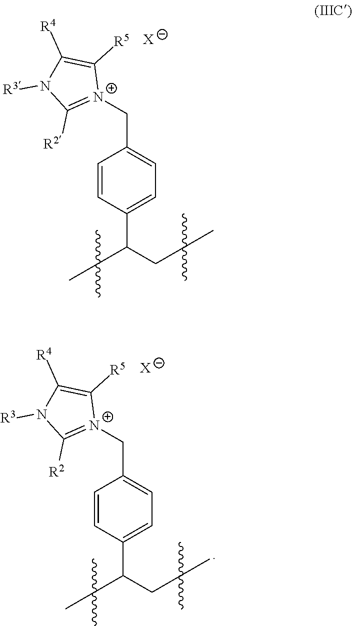

In some such embodiments, X— is halide.

In some embodiments of the inventive polymer, the sum of carbon atoms in W and Y is 1 or 3.

The polymers described herein can be cast or otherwise formed into membranes as described herein. The membranes are useful in, e.g., hydrogen generation devices, fuel cells, and water purification devices.

In some embodiments, the polymer comprises, in addition to the IRUs, hydrocarbon repeating units (HRUs) and the polymers have the following structure:

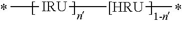

wherein n′ is from 0.05 to 1.0 and represents the mole fraction of IRU in the polymer. The IRU and HRU units may be random or sequentially placed. In some embodiments, n′ is 0.1 to 0.4.

The polymers may be random or block copolymers. Adjacent IRU and HRU or IRU and IRU or HRU and HRU may be connected by a carbon-carbon single bond or a carbon-carbon double bond as illustrated below. In some embodiments, for example, when the polymer is to be used in an AAEM, at least some of the double bonds are reduced. In some embodiments, 50-100% (e.g., 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100%) of the carbon-carbon double bonds are reduced to carbon-carbon single bonds.

The polymer can be crosslinked or not crosslinked. In some embodiments, the polymer is not cross-linked. An example of an embodiment of an unsaturated non-crosslinked polymer is shown in Structure I:

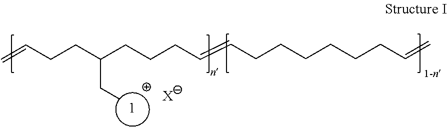

in which

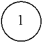

is an imidazolium residue.

An example of an embodiment of a saturated non-crosslinked polymer is shown in Structure II:

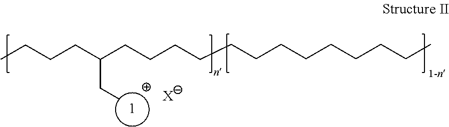

Embodiment of the inventive polymers can be synthesized by, for example, ring-opening metathesis polymerization (ROMP), which can be carried out using a transition metal (e.g., ruthenium-based) metathesis catalyst (e.g., a second generation Grubbs-type catalyst). The steps of the ROMP polymerization are known in the art. For example, the method includes the steps of providing a strained-ring monomer (or plurality of strained ring monomers) and a catalyst, such as a ruthenium-based alkene metathesis catalyst. The monomer(s) and catalyst are combined optionally in the presence of a solvent. The reaction mixture is heated under conditions such that a polymer is formed. By strained ring structure it is meant that at least one bond angle in the molecule differs from the optimal tetrahedral (109.5°) (for sp³ bonds) or trigonal planar (120°) (for sp² bonds) bond angles such that the ground state energy of the carbocycle is above that of a carbocycle having all normal bond angles.

For ROMP, an imidazolium monomer (IM) (some embodiments of which are encompassed by the formula (II) genus) from which an IRU is derived is a hydrocarbon which has at least one alkene group that can be polymerized. The IM can have multiple alkene moieties which can result in the polymer being crosslinked as a result of polymerization of two alkene moieties from two different IM units. For example, an IM and a monomer with multiple alkene functional groups can be copolymerized to provide crosslinked polymers.

### Definitions

The term “alkyl” refers to a radical of a straight-chain or branched saturated hydrocarbon group having from 1 to 18 carbon atoms (“C₁₋₁₈ alkyl”). In some embodiments, an alkyl group has 1 to 12 carbon atoms (“C₁₋₁₂ alkyl”). In some embodiments, an alkyl group has 1 to 8 carbon atoms (“C₁₋₈ alkyl”). In some embodiments, an alkyl group has 1 to 6 carbon atoms (“C₁₋₆ alkyl”). In some embodiments, an alkyl group has 1 to 3 carbon atoms (“C₁₋₃ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆ alkyl, e.g., —CF₃, Bn).

The term “alkenyl” refers to a radical of a straight-chain or branched hydrocarbon group having from 2 to 18 carbon atoms and one or more carbon-carbon double bonds (e.g., 1, 2, 3, or 4 double bonds). In some embodiments, an alkenyl group has 2 to 12 carbon atoms (“C₂₋₁₂ alkenyl”). In some embodiments, an alkenyl group has 2 to 8 carbon atoms (“C₂₋₈ alkenyl”).

In some embodiments, an alkenyl group has 2 to 6 carbon atoms (“C₂₋₆ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₈ alkenyl. In certain embodiments, the alkenyl group is a substituted C₂₋₁₈ alkenyl. In an alkenyl group, a C═C double bond for which the stereochemistry is not specified

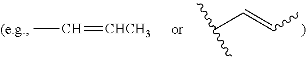

may be an (E)- or (Z)-double bond.

The term “alkynyl” refers to a radical of a straight-chain or branched hydrocarbon group having from 2 to 18 carbon atoms and one or more carbon-carbon triple bonds (e.g., 1, 2, 3, or 4 triple bonds) (“C₂₋₁₈ alkynyl”). In some embodiments, an alkynyl group has 2 to 12 carbon atoms (“C₂₋₁₂ alkynyl”). In some embodiments, an alkynyl group has 2 to 8 carbon atoms (“C₂₋₈ alkynyl”). In some embodiments, an alkynyl group has 2 to 6 carbon atoms (“C₂₋₆ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₈ alkynyl. In certain embodiments, the alkynyl group is a substituted C₂₋₁₈ alkynyl.

The term “carbocyclyl” or “carbocyclic” refers to a radical of a non-aromatic cyclic hydrocarbon group having from 3 to 18 ring carbon atoms (“C₃₋₁₈ carbocyclyl”) and zero heteroatoms in the non-aromatic ring system. In some embodiments, a carbocyclyl group has 3 to 12 ring carbon atoms (“C₃₋₁₂ carbocyclyl”). In some embodiments, a carbocyclyl group has 3 to 8 ring carbon atoms (“C₃₋₈ carbocyclyl”). In some embodiments, a carbocyclyl group has 3 to 6 ring carbon atoms (“C₃₋₆ carbocyclyl”). In some embodiments, a carbocyclyl group has 5 to 6 ring carbon atoms (“C₂₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like.

Exemplary C₃₋₈ carbocyclyl groups include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include, without limitation, the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₄ carbocyclyl. In certain embodiments, the carbocyclyl group is a substituted C₃₋₁₄ carbocyclyl.

In some embodiments, “cycloalkyl” is a monocyclic, saturated carbocyclyl group having from 3 to 18 ring carbon atoms (“C₃₋₁₈ cycloalkyl”). In some embodiments, a cycloalkyl group has 3 to 12 ring carbon atoms (“C₃₋₁₂ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 7 ring carbon atoms (“C₅₋₇ cycloalkyl”). Examples of C₅₋₆ cycloalkyl groups include cyclopentyl (C₈) and cyclohexyl (C₆). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₈ cycloalkyl. In certain embodiments, the cycloalkyl group is a substituted C₃₋₁₈ cycloalkyl.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

The term “saturated” refers to a moiety that does not contain a double or triple bond, i.e., the moiety only contains single bonds.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, carbocyclylene is the divalent moiety of carbocyclyl, and arylene is the divalent moiety of aryl.

The terms “haloalkyl” means alkyl, as defined above, substituted with one or more halogen atoms. The term “halogen” means F, Cl, Br or I. Preferably the halogen in a haloalkyl is F.

The term “hydrocarbyl” as used herein refers to a monovalent hydrocarbon radical, such as an alkyl, an alkenyl, an alkynyl, an aryl, a carbocyclyl, or a cycloalkyl.

The terms “hydrocarbyl”, “alkyl”, “alkenyl”, “alkynyl”, “alkylene, “aryl”, “carbocyclyl”, and “cycloalkyl”, as used throughout the specification, examples, and claims are intended to include both “unsubstituted” and “substituted” groups, the latter of which refers to the moieties having substituents replacing a hydrogen on one or more carbons of the hydrocarbon. Such substituents, if not otherwise specified, can include, for example, a halogen, a haloalkyl, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an arylalkyl, or an aromatic or heteroaromatic moiety. It will be understood by those skilled in the art that the moieties substituted on the hydrocarbon chain can themselves be substituted, if appropriate. For instance, the substituents of a substituted alkyl may include substituted and unsubstituted forms of amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like.

The term “C_{x-y}” when used in conjunction with a chemical moiety, such as, acyl, acyloxy, alkyl, alkenyl, alkynyl, or alkoxy is meant to include groups that contain from x to y carbons in the chain. For example, the term “C_{x-y}alkyl” refers to substituted or unsubstituted saturated hydrocarbon groups, including straight-chain alkyl and branched-chain alkyl groups that contain from x to y carbons in the chain, including haloalkyl groups such as trifluoromethyl and 2,2,2-trifluoroethyl, etc. C₀ alkyl indicates a hydrogen where the group is in a terminal position, a bond if internal. The terms “C_{2-y}alkenyl” and “C_{2-y}alkynyl” refer to substituted or unsubstituted unsaturated aliphatic groups analogous in length and possible substitution to the alkyls described above, but that contain at least one double or triple bond respectively.

Numeric ranges are inclusive of the numbers defining the range. Measured and measureable values are understood to be approximate, taking into account significant digits and the error associated with the measurement. As used in this application, the terms “about” and “approximately” have their art-understood meanings; use of one vs the other does not necessarily imply different scope. Unless otherwise indicated, numerals used in this application, with or without a modifying term such as “about” or “approximately”, should be understood to encompass normal divergence and/or fluctuations as would be appreciated by one of ordinary skill in the relevant art. In certain embodiments, the term “approximately” or “about” refers to a range of values that fall within 10%, 9%, 8%, 7%, 6%, 5%, 4%, 3%, 2%, 1%, or less in either direction (greater than or less than) of a stated reference value unless otherwise stated or otherwise evident from the context (except where such number would exceed 100% of a possible value).

As used herein, the term “composite material” refers to a material made from two or more constituent materials with significantly different physical or chemical properties separated by a distinct interface. When combined, the two or more constituent materials produce a composite material with characteristics different from the individual components. The individual components remain separate and distinct within the composite material, thus differentiating composite materials from mixtures and solid solutions.

As used herein, the term “reinforcement” refers to any material that can provide mechanical support to the polyelectrolyte without interfering with the function of the polyelectrolyte. For example, a reinforcement can be mixed with the polyelectrolyte, it can be impregnated with the polyelectrolyte, or it can be coated with the polyelectrolyte to provide the composite material. A reinforcement can be an inorganic material, such as a ceramic material, a polymer, or a composite of an inorganic material and a polymer, such as fiberglass.

As used herein, “support material” refers to a material having mechanical strength and chemical durability, which can be impregnated and/or coated with the polyelectrolyte to provide the composite material. The support material can be made, for example, of a ceramic material or a polymer, such as a polyolefin, a polysulfone, or a polyamide. In some embodiments, the support comprises a polyimide, a polybenzimidazole, a polyphenylsulfone, a polyphenyl ether, cellulose nitrate, cellulose diacetate, cellulose triacetate, polypropylene, polyethylene, polyvinylidene fluoride, poly(phenylene sulfide), poly(vinyl chloride), polystyrene, poly(methyl methacrylate), polyacrylonitrile, polytetrafluoroethylene, polyetheretherketone, polycarbonate, polyvinyltrimethylsilane, polytrimethylsilylpropyne, poly(ether imide), poly(ether sulfone), polyoxadiazole, or poly(phenylene oxide), or a combination or copolymer thereof. The support material can be in a form of a film.

As used herein, the term “porous material impregnated with polyelectrolyte” refers to a porous material that contains a polyelectrolyte within its pores. A porous material can be impregnated with a polyelectrolyte, for example, by soaking the material in a solution of the polyelectrolyte. Alternatively, the porous material can be impregnated with a solution of one or more monomers, followed by a polymerization reaction within the pores of the material. Additionally, once a porous material impregnated with a polyelectrolyte, the polyelectrolyte can undergo further chemical transformations, such as cross-linking, within the pores of the material.

As used herein, the term “repeat unit” (also known as a monomer unit) refers to a chemical moiety which periodically repeats itself to produce the complete polymer chain (except for the end-groups) by linking the repeat units together successively. A polymer can contain one or more different repeat units.

The term “degree of crosslinking”, as used herein, refers to the fraction of repeat units that are capable of forming cross-link compared to the total number of repeat units in a polymer. Degree of crosslinking is generally expressed in mole percent with respect to the total number of repeat units in a polymer.

As used herein, the term “polyelectrolyte” refers to polymer refers to a polymer which under a particular set of conditions has a net positive or negative charge due to the presence of charged repeat units. In some embodiments, a polyelectrolyte is or comprises a polycation; in some embodiments, a polyelectrolyte is or comprises a polyanion. Polycations have a net positive charge and polyanions have a net negative charge. The net charge of a given polyelectrolyte may depend on the surrounding chemical conditions, e.g., on the pH.

As used herein, “ion exchange capacity” refers to the total number of active sites or functional groups responsible for ion exchange in a polyelectrolyte. Ion exchange capacity for a hydroxide-exchanging polyelectrolyte can be calculated according to Equation 1 based on the experimentally determined number of hydroxide ions that have been exchanged within the polymer. For polyelectrolyte-containing composite membranes ion accessibility is measured instead and calculated according to Equation 2, because the mass of the sample is a sum of the dry weight of the support plus the polymer.

$$IEC = \frac{meq {OH}^{-}}{Dry weight of polymer} \qquad Equation 1$$

$$IA = \frac{meq {OH}^{-}}{Dry weight of support + polymer} \qquad Equation 2$$

As used herein, “ionic conductivity” refers to the ability of the material, such as a polyelectrolyte, promote the movement of an ion through the material. For example, through-plane ionic conductivity of a polyelectrolyte membrane can be calculated based on the bulk resistance (R), the membrane active area (L), and the membrane thickness (A) according to Equation 3.

$$σ = \frac{L}{A \times R} \qquad Equation 3$$

As used herein, “porosity” refers to a fraction of the empty volume compared the total volume of the material. Porosity is a measureless value between 0 and 1, or as a percentage between 0% and 100%.

As used herein, the term “void space” or “void volume” refers to porosity of a composite that comprises a porous material impregnated with the polymer. Void space is different form the porosity of the porous material, since some of the pore volume of the porous material is taken up by the polymer disposed within the pore system of the material. A void space can be about 1%, about 2.5%, about 5%, about 7.5%, about 10%, about 12.5%, about 15%, about 17.5%, about 20%, about 25%, about 30%, about 35%, about 40%, about 45%, or about 50%.

As used herein, the term “polyolefin” refers to a polymer produced by polymerization of organic molecules containing a carbon-carbon double bond. The backbone of a polyolefin contains a saturated chain of carbon-carbon bonds. In some embodiments, the carbon atoms in the backbone of a polyolefin can be substituted with hydrocarbyl groups. For example, the carbon atoms in the backbone of a polyolefin can be substituted with alkyl, cycloalkyl, or aryl groups. In some embodiments, the carbon atoms in the backbone of a polyolefin can be substituted with halogens, such as fluorine.

As used herein, “perfluorinated polyolefin” refers to a polyolefin in which all hydrogen atoms have been substituted with fluorines.

As used herein, “inorganic material” refers to a material that does not contain chains of carbon-carbon bonds, except for elementary carbon allotropes, such as graphite, graphene, diamond, or carbon nanotubes, which are included in inorganic materials. Examples of inorganic materials include glass, ceramic materials, and metal oxides such as TiO₂, Al₂O₃, ZnO.

The term “ceramic material”, as used herein, refers to a crystalline or amorphous oxide, nitride or carbide of a metallic or non-metallic element. Ceramic materials are generally hard, brittle, heat-resistant and corrosion-resistant. Examples of ceramic materials include SiC, Si₃N₄, TiC, ZnO, ZrO₂, Al₂O₃, and MgO.

The term “current collector”, as used herein, refers to the electrical conductor between the electrode and external circuits in an electrochemical device such as a battery cell.

In a first embodiment, the present invention is a composite material, comprising a reinforcement material and a polyelectrolyte in contact with said reinforcement material, wherein the polyelectrolyte comprises a first repeat unit selected from a moiety represented by the structural formula I, II, II, or IV:

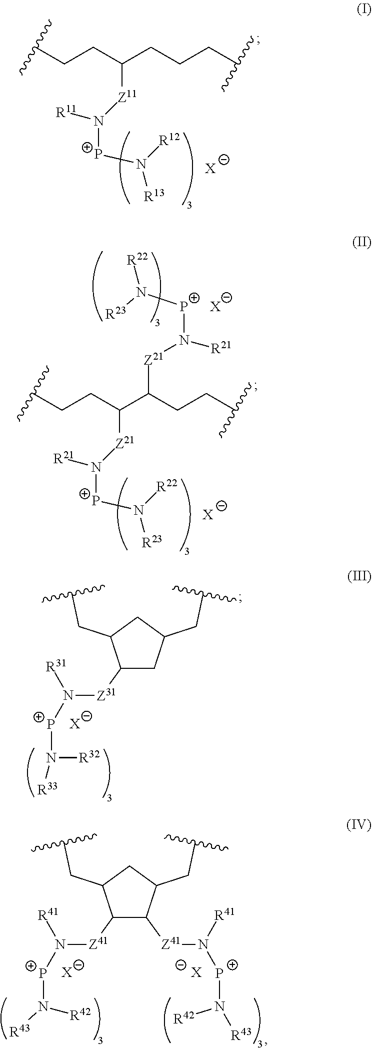

wherein:
[symbol] indicates the point of attachment to other repeat units;
R¹¹, R²¹, R³¹, and R⁴¹, each independently, is a C₁₋₄ alkyl;
R¹², R¹³, R²², R²³, R³², R³³, R⁴² and R⁴³, each independently, is a C₁₋₄ alkyl or a C₅₋₇ cycloalkyl;
Z¹¹, Z²¹, Z³¹, and Z⁴¹, each independently, is a C₁₋₁₀ alkylene or a *O—(C₁₋₁₀ alkylene), wherein * indicates the point of attachment to the polymer backbone;
X⁻ is a halide, OH⁻, HCO₃⁻, CO₃²⁻, CO₂(R¹⁰)⁻, O(R¹⁰)⁻, NO₃⁻, CN⁻, PF₆⁻, or BF₄⁻; and
R¹⁰ is a C₁₋₄ alkyl.

In a first aspect of the first embodiment, the reinforcement material comprises a polymer, an inorganic material, or a combination thereof. For example, reinforcement material comprises a polyolefin, a polyphenylene, a polyester, a polyamide, or a polysulfone. For example, the reinforcement material comprises a perfluorinated polyolefin, such as polytetrafluoroethylene. For example, the reinforcement material comprises a polyimide, a polybenzimidazole, a polyphenylsulfone, a polyphenyl ether, polytetrafluoroethylene, cellulose nitrate, cellulose diacetate, cellulose triacetate, polypropylene, polyethylene, polyvinylidene fluoride, poly(phenylene sulfide), polyvinyl chloride, polystyrene, poly(methyl methacrylate), polyacrylonitrile, polyetheretherketone, polycarbonate, polyvinyltrimethylsilane, polytrimethylsilylpropyne, poly(ether imide), poly(ether sulfone), polyoxadiazole, poly(phenylene sulfide), or poly(phenylene oxide), or a combination or copolymer thereof. The composite material can comprise polyethylene, polypropylene, polytetrafluoroethylene, polyvinyl chloride, or polyvynyldifluoroethylene. Alternatively or additionally, the reinforcement material comprises fiberglass or a ceramic material.

In a second aspect of the first embodiment, the composite material is an admixture of the reinforcement material and the polyelectrolyte. Alternatively or additionally, the reinforcement is a first layer; the electrolyte is a second layer; and the first layer is in contact with at least one second layer. Alternatively or additionally, the reinforcement is a porous material; and the porous material is impregnated with the electrolyte. The remainder of the values and example values of the variables of the composite material are as described above with respect to the first aspect of the first embodiment.

In a third aspect of the first embodiment, the reinforcement is a porous material and the porous material has from about 40% to about 90% porosity, such as about 40%, about 45%, about 50%, about 55%, about 60%, about 65%, about 70%, about 75%, about 80%, about 85%, or about 90% porosity. For example, the porous material has from about 70% to about 85% porosity, such as about 73% porosity. The remainder of the values and example values of the variables of the composite material are as described above with respect to the first and second aspects of the first embodiment.

In a fourth aspect of the first embodiment, the reinforcement is a porous material and an average size of pores of the porous material is from about 50 nm to about 500 μm, such as about 50 nm, about 100 nm, about 200 nm, about 300 nm, about 400 nm, about 500 nm, about 600 nm, about 700 nm, about 800 nm, about 900 nm, about 1 μm, about 1 μm, about 1 μm, about 10 μm, about 25 μm, about 50 μm, about 100 μm, about 150 μm, about 200 μm, about 250 μm, about 300 μm, about 350 μm, about 400 μm, about 450 μm, or about 500 μm. For example, the average size of the pores is from about 100 nm to about 10 μm, such as from about 300 nm to about 1 μm. For example, the average size of the pores is about 450 nm. The remainder of the values and example values of the variables of the composite material are as described above with respect to the first through the third aspects of the first embodiment.

In a fifth aspect of the first embodiment, the composite material is a film having a thickness from about 1 μm to about 300 μm, such as about 1 μm, about 5 μm, about 10 μm, about 20 μm, about 30 μm, about 40 μm, about 50 μm, about 60 μm, about 70 μm, about 80 μm, about 90 μm, about 100 μm, about 120 μm, about 140 μm, about 160 μm, about 180 μm, about 200 μm, about 220 μm, about 240 μm, about 260 μm, about 280 μm, or about 300 μm. For example, the composite material is a film having a thickness from about 25 μm to about 75 μm, such as about 50 μm. The remainder of the values and example values of the variables of the composite material are as described above with respect to the first through the fourth aspects of the first embodiment.

In a sixth aspect of the first embodiment, the polyelectrolyte further comprises a second repeat unit Z², wherein Z² is a linear C₂₋₈ alkylene or a chemical moiety represented by the following structural formula

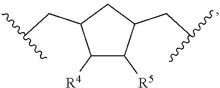

wherein:
[symbol] indicates the point of attachment to other repeat units;
the linear C₂₋₈ alkylene is unsubstituted or substituted with one or more C₁₋₃ alkyl, C₁₋₃ haloalkyl, C₁₋₃ alkyl(C₆₋₁₄ aryl), or —(C₁₋₃ alkylene)O(C₁₋₃ alkylene)C₆₋₁₄ aryl, wherein each aryl is optionally substituted with 1 to 3 C₁₋₃ alkyls or C₁₋₃ haloalkyls; and
R⁴ and R⁵, each independently, is H, a C₁₋₃ alkyl, a C₁₋₃ haloalkyl, a C₃₋₈ alkenyl, a C₁₋₃ alkyl(C₆₋₁₄ aryl), or a —(C₁₋₃ alkylene)O(C₁₋₃ alkylene)(C₆₋₁₄ aryl), wherein each aryl is optionally substituted with 1 to 3 C₁₋₃ alkyls or C₁₋₃ haloalkyls, or
R⁴ and R⁵ taken together with the carbon atoms to which they are attached form a C₅₋₇ cycloalkyl; wherein the C₅₋₇ cycloalkyl is optionally substituted with a —C(O)O(C₁₋₃ alkyl) or a C₃₋₈ alkenyl. The remainder of the values and example values of the variables of the composite material are as described above with respect to the first through the fifth aspects of the first embodiment.

In a seventh aspect of the first embodiment, the polyelectrolyte comprises at least a first polymer chain and a second polymer chain, and the first polymer chain is cross-linked to the second polymer chain. For example, the polyelectrolyte further comprises at least one connecting moiety, wherein the connecting moiety is selected from a moiety represented by the following structural formulas

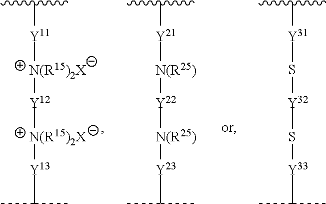

wherein
[symbol] indicates the point of attachment of the connecting moiety to the first polymer chain;
[symbol] indicates the point of attachment of the connecting moiety to the second polymer chain;
Y¹¹, Y¹³, Y²¹ and Y²³, each independently, is a C₁₋₃ alkylene;
Y³¹ and Y³³, each independently, is a C₁₋₃ alkylene;
R¹⁵ and R²⁵, each independently, is a C₁₋₄ alkyl; and
Y¹², Y²³ and Y³², each independently, is a C₂₋₁₀ alkylene or a (C₁₋₃ alkylene)(C₆ aryl)(C₁₋₃ alkylene). The remainder of the values and example values of the variables of the composite material are as described above with respect to the first through the sixth aspects of the first embodiment.

In an eighth aspect of the first embodiment, the polyelectrolyte comprises at least a first polymer chain, a second polymer chain, and a third polymer chain, and the first polymer chain is cross-linked to the second polymer chain and to the third polymer chain. The remainder of the values and example values of the variables of the composite material are as described above with respect to the first through the seventh aspects of the first embodiment. For example, the polyelectrolyte further comprises at least one connecting moiety, wherein the connecting moiety is selected from a moiety represented by the following structural formulas

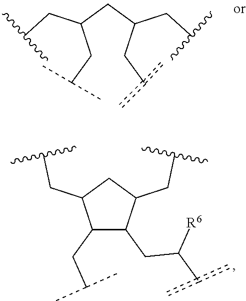

wherein
[symbol] indicates the point of attachment of the connecting moiety to the first polymer chain;
[symbol] indicates the point of attachment of the connecting moiety to the second polymer chain;
[symbol] indicates the point of attachment of the connecting moiety to the third polymer chain; and
R⁶ is H or a —C(O)O(C₁₋₃ alkyl). The remainder of the values and example values of the variables of the composite material are as described above with respect to the first through the seventh aspects of the first embodiment.

In a ninth aspect of the first embodiment, R¹¹ is methyl. The remainder of the values and example values of the variables of the composite material are as described above with respect to the first through the eighth aspects of the first embodiment.

In a tenth aspect of the first embodiment, R²¹ is methyl. The remainder of the values and example values of the variables of the composite material are as described above with respect to the first through the ninth aspects of the first embodiment.

In an eleventh aspect of the first embodiment, R³¹ is methyl. The remainder of the values and example values of the variables of the composite material are as described above with respect to the first through the tenth aspects of the first embodiment.

In a twelfth aspect of the first embodiment, R⁴¹ is methyl. The remainder of the values and example values of the variables of the composite material are as described above with respect to the first through the eleventh aspects of the first embodiment.

In a thirteenth aspect of the first embodiment, R¹² is a C₁₋₄ alkyl. For example, R¹² is methyl. Alternatively, R¹² is isopropyl. The remainder of the values and example values of the variables of the composite material are as described above with respect to the first through the twelfth aspects of the first embodiment.

In a fourteenth aspect of the first embodiment, R²² is a C₁₋₄ alkyl. For example, R²² is methyl. Alternatively, R²² is isopropyl. The remainder of the values and example values of the variables of the composite material are as described above with respect to the first through the thirteenth aspects of the first embodiment.

In a fifteenth aspect of the first embodiment, R³² is a C₁₋₄ alkyl. For example, R³² is methyl. Alternatively, R³² is isopropyl. The remainder of the values and example values of the variables of the composite material are as described above with respect to the first through the fourteenth aspects of the first embodiment.

In a sixteenth aspect of the first embodiment, R⁴² is a C₁₋₄ alkyl. For example, R⁴² is methyl. Alternatively, R⁴² is isopropyl. The remainder of the values and example values of the variables of the composite material are as described above with respect to the first through the fifteenth aspects of the first embodiment.

In a seventeenth aspect of the first embodiment, R¹³ is a C₅₋₇ cycloalkyl. For example, R¹³ is cyclohexyl. The remainder of the values and example values of the variables of the composite material are as described above with respect to the first through the sixteenth aspects of the first embodiment.

In an eighteenth aspect of the first embodiment, R¹³ is a C₁₋₄ alkyl. For example, R¹³ is methyl. The remainder of the values and example values of the variables of the composite material are as described above with respect to the first through the sixteenth aspects of the first embodiment.

In a nineteenth aspect of the first embodiment, R²³ is a C₅₋₇ cycloalkyl. For example, R²³ is cyclohexyl. The remainder of the values and example values of the variables of the composite material are as described above with respect to the first through the eighteenth aspects of the first embodiment.

In a twentieth aspect of the first embodiment, R²³ is a C₁₋₄ alkyl. For example, R²³ is methyl. The remainder of the values and example values of the variables of the composite material are as described above with respect to the first through the eighteenth aspects of the first embodiment.

In a twenty-first aspect of the first embodiment, R³³ is a C₅₋₇ cycloalkyl. For example, R³³ is cyclohexyl. The remainder of the values and example values of the variables of the composite material are as described above with respect to the first through the twentieth aspects of the first embodiment.

In a twenty-second aspect of the first embodiment, R³³ is a C₁₋₄ alkyl. For example, R³³ is methyl. The remainder of the values and example values of the variables of the composite material are as described above with respect to the first through the twentieth aspects of the first embodiment.

In a twenty-third aspect of the first embodiment, R⁴³ is a C₅₋₇ cycloalkyl. For example, R¹³ is cyclohexyl. The remainder of the values and example values of the variables of the composite material are as described above with respect to the first through the twenty-second aspects of the first embodiment.

In a twenty-fourth aspect of the first embodiment, R⁴³ is a C₁₋₄ alkyl. For example, R⁴³ is methyl. The remainder of the values and example values of the variables of the composite material are as described above with respect to the first through the twenty-second aspects of the first embodiment.

In a twenty-fifth aspect of the first embodiment, Z² is a linear substituted or unsubstituted C₂₋₈ alkylene, such as Z² is a linear C₈ alkylene. For example, the linear C₈ alkylene is substituted with a C₁₋₃ alkyl, a C₁₋₃ haloalkyl, a C₁₋₃ alkyl(C₆₋₁₄ aryl), or a —(C₁₋₃ alkylene)O(C₁₋₃ alkylene)(C₆₋₁₄ aryl), e.g., the linear C₈ alkylene is substituted with —CH₂F, —CH₂CH₂C₆H₅, or —CH₂OCH₂(3,5-(CF₃)₂C₆H₃). Alternatively, Z² is an unsubstituted linear C₈ alkylene. The remainder of the values and example values of the variables of the composite material are as described above with respect to the first through the twenty-fourth aspects of the first embodiment.

In a twenty-sixth aspect of the first embodiment, Z² is a chemical moiety represented by the following structural formula

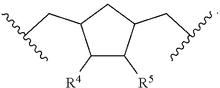

For example, R⁴ and R⁵ is each independently H or a C₃₋₈ alkenyl. Alternatively, R⁴ and R⁵ taken together with the carbon atoms to which they are attached form a C₅₋₇ cycloalkyl, e.g., R⁴ and R⁵ taken together with the carbon atoms to which they are attached form a C₅₋₇ cycloalkyl substituted with a —C(O)O(C₁₋₃ alkyl). The remainder of the values and example values of the variables of the composite material are as described above with respect to the first through the twenty-fourth aspects of the first embodiment.

In a twenty-seventh aspect of the first embodiment, the polyelectrolyte is represented by structural formulas V or VI:

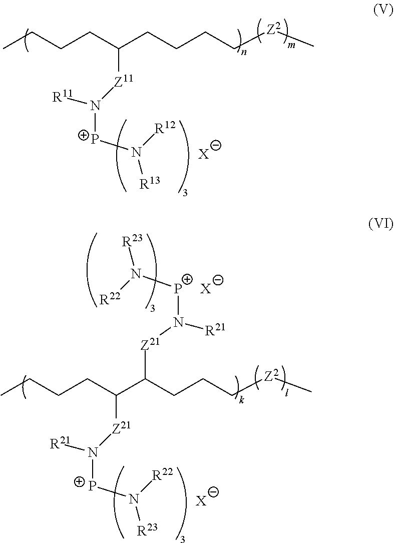

wherein
n is an integer from 2 to 2000;
m is an integer from 0 to 10000;
k is an integer from 1 to 1000;
l is an integer from 0 to 10000;
   For example, the polyelectrolyte is represented by structural formula VII:

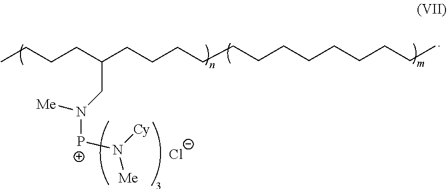

The remainder of the values and example values of the variables of the composite material are as described above with respect to the first through the twenty-sixth aspects of the first embodiment.

In a twenty-eighth aspect of the first embodiment, the polyelectrolyte comprises from about 10 mol-% to about 100 mol-% of the first repeat units represented by the structural formula I, such as about 10 mol-%, about 20 mol-%, about 30 mol-%, about 40 mol-%, about 50 mol-%, about 60 mol-%, about 70 mol-%, about 80 mol-%, about 90 mol-%, or about 100 mol-% For example, the polyelectrolyte comprises from about 20 wt. % to about 60 wt. % of the first repeat units represented by the structural formula I, such as from about 30 mol-% to about 50 mol-% of the first repeat units represented by the structural formula I, e.g., about 37 mol-% of the first repeat units represented by the structural formula I. The remainder of the values and example values of the variables of the composite material are as described above with respect to the first through the twenty-seventh aspects of the first embodiment.

In a twenty-eighth aspect of the first embodiment, the degree of cross-linking of the polyelectrolyte is from about 5% to about 15%. The remainder of the values and example values of the variables of the composite material are as described above with respect to the first through the twenty-seventh aspects of the first embodiment.

In a twenty-ninth aspect of the first embodiment, the molecular weight of the polyelectrolyte is from about 5,000 g/mol to about 1,000,000 g/mol, such as about 5,000 g/mol, about 10,000 g/mol, about 50,000 g/mol, about 100,000 g/mol, about 200,000 g/mol, about 300000 g/mol, about 400,000 g/mol, about 500,000 g/mol, about 600,000 g/mol, about 700,000 g/mol, about 800,000 g/mol, about 900,000 g/mol, or about 1,000,000 g/mol. For example, the molecular weight of the polyelectrolyte is from about 200,000 g/mol to about 800,000 g/mol, such as from about 300,000 g/mol to about 500,000 g/mol, e.g., about 360,000 g/mol. The remainder of the values and example values of the variables of the composite material are as described above with respect to the first through the twenty-eighth aspects of the first embodiment.

In a second embodiment, the present invention is a membrane, comprising a film of any composite material described herein with respect to the first embodiment and various aspects thereof.

In a third embodiment, the present invention is a membrane electrode assembly, comprising any membrane described herein with respect to the second embodiment and various aspects thereof and an electrode.

In a fourth embodiment, the present invention is an electrochemical device comprising any membrane electrode assembly described herein with respect to the third embodiment and various aspects thereof and a current collector.

In a first aspect of the fourth embodiment, the device is an electrolyzer.

In a fifth embodiment, the invention is a method of making any composite material described herein with respect to the first embodiment and various aspects thereof, comprising:
(a) providing a first solution comprising the polyelectrolyte;
(b) contacting the first solution with the reinforcement material at a first temperature for a first period of time, thereby providing a composite material precursor;
(c) placing the composite material precursor on a surface at a second temperature for the second period of time, thereby providing a dried composite material precursor; and
(d) removing the dried composite material from the surface, thereby providing a composite material.

In a first aspect of the fifth embodiment, removing the dried composite material from the surface comprises contacting the dried composite material with a removing solvent at a third temperature for a third period of time.

In a second aspect of the fifth embodiment, the removing solvent comprises water. The remainder of the values and example values of the variables of the composite material are as described above with respect to the first aspect of the fifth embodiment.

In a third aspect of the fifth embodiment, the third period of time is from about 6 hours to about 24 hours. For example, the third period of time is about 6 hours. The remainder of the values and example values of the variables of the composite material are as described above with respect to the first and second aspects of the fifth embodiment.

In a fourth aspect of the fifth embodiment, the third temperature is from about 50° C. to about 90° C., such as from about 60° C. to about 80° C. For example, the third temperature is about 60° C. The remainder of the values and example values of the variables of the composite material are as described above with respect to the first through the third aspects of the fifth embodiment.

In a fifth aspect of the fifth embodiment, the first solution comprises a first solvent. The first solvent is, for example, water, an alcohol, such as methanol, ethanol, or isopropanol, toluene, acetonitrile, dimethylsulfoxide, acetone, dimethylformamide, N-methyl-2-pyrrolidone, or a mixture thereof. For example, the first solvent is a mixture of 80% ethanol and 20% toluene by volume. The remainder of the values and example values of the variables of the composite material are as described above with respect to the first through the fourth aspects of the fourth embodiment.

In a sixth aspect of the fifth embodiment, contacting the first solution with the reinforcement material comprises immersing the reinforcement material in the first solution. The remainder of the values and example values of the variables of the composite material are as described above with respect to the first through the fifth aspects of the fifth embodiment.

In a seventh aspect of the fifth embodiment, the first temperature is from about 15° C. to about 80° C., such as about 15° C., about 20° C., about 25° C., about 30° C., about 35° C., about 40° C., about 45° C., about 50° C., about 55° C., about 60° C., about 65° C., about 70° C., about 75° C., or about 80° C. For example, the first temperature is about 20° C. The remainder of the values and example values of the variables of the composite material are as described above with respect to the first through the sixth aspects of the fifth embodiment.

In an eighth aspect of the fifth embodiment, the first period of time is from about 1 hour to about 24 hours, such as about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours. For example, the first period of time is about 18 hours. The remainder of the values and example values of the variables of the composite material are as described above with respect to the first through the seventh aspects of the fifth embodiment.

In a ninth aspect of the fifth embodiment, the concentration of the polyelectrolyte in the first solution is from about 30 mM to about 300 mM, such as about 30 mM, about 40 mM, about 50 mM, about 60 mM, about 70 mM, about 80 mM, about 90 mM, about 100 mM, about 120 mM, about 140 mM, about 150 mM, about 160 mM, about 170 mM, about 180 mM, about 110 mM, about 130 mM, about 140 mM, about 190 mM, about 200 mM, about 220 mM, about 240 mM, about 260 mM, about 280 mM, or about 300 mM. For example, the concentration of the polyelectrolyte in the first solution is from about 85 mM. The remainder of the values and example values of the variables of the composite material are as described above with respect to the first through the eighth aspects of the fifth embodiment.

While this invention has been particularly shown and described with references to example embodiments thereof, it will be understood by those skilled in the art that various changes in form and details may be made therein without departing from the scope of the invention encompassed by the appended claims.

The teachings of all patents, published applications and references cited herein are incorporated by reference in their entirety.

What is claimed is:

1. A composite material, comprising a reinforcement material and a polyelectrolyte in contact with said reinforcement material, wherein the polyelectrolyte comprises a first repeat unit selected from a moiety represented by the structural formula I, II, II, or IV: 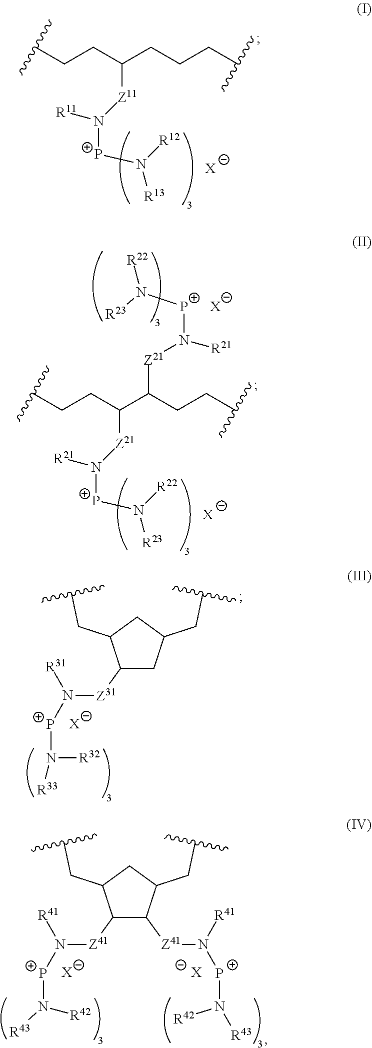
wherein: [symbol]
indicates the point of attachment to other repeat units;
R¹¹, R²¹, R³¹, and R⁴¹, each independently, is a C₁₋₄ alkyl;
R¹², R¹³, R²², R²³, R³², R³³, R⁴² and R⁴³, each independently, is a C₁₋₄ alkyl or a C₅₋₇ cycloalkyl;
Z¹¹, Z²¹, Z³¹, and Z⁴¹, each independently, is a C₁₋₁₀ alkylene or a *O—(C₁₋₁₀ alkylene),
wherein * indicates the point of attachment to the polymer backbone;
X⁻ is a halide, OH⁻, HCO₃⁻, CO₃²⁻, CO₂(R¹⁰)⁻, O(R¹⁰)⁻, NO₃⁻, CN⁻, PF₆⁻, or BF₄⁻; and
R¹⁰ is a C₁₋₄ alkyl.

2. The composite material of claim 1, wherein the reinforcement material comprises a polymer, an inorganic material, or a combination thereof.

3. The composite material of any one of claims 1 or 2, wherein the reinforcement material comprises a polyolefin, a polyphenylene, a polyester, a polyamide, or a polysulfone.

4. The composite material of any one of claims 1-3, wherein the reinforcement material comprises a perfluorinated polyolefin.

5. The composite material of any one of claims 1-3, wherein the reinforcement material comprises a polyimide, a polybenzimidazole, a polyphenylsulfone, a polyphenyl ether, polytetrafluoroethylene, cellulose nitrate, cellulose diacetate, cellulose triacetate, polypropylene, polyethylene, polyvinylidene fluoride, poly(phenylene sulfide), polyvinyl chloride, polystyrene, poly(methyl methacrylate), polyacrylonitrile, polyetheretherketone, polycarbonate, polyvinyltrimethylsilane, polytrimethylsilylpropyne, poly(ether imide), poly(ether sulfone), polyoxadiazole, poly(phenylene sulfide), or poly(phenylene oxide), or a combination or copolymer thereof.

6. The composite material of any one of claims 1-3, wherein the reinforcement material comprises polyethylene, polypropylene, polytetrafluoroethylene, polyvinyl chloride, or polyvynyldifluoroethylene.

7. The composite material of claim 6, wherein the reinforcement material comprises polytetrafluoroethylene.

8. The composite material of any one of claims 1-3, wherein the reinforcement material comprises fiberglass or a ceramic material.

9. The composite material of any one of claims 1-8, wherein the composite material is an admixture of the reinforcement material and the polyelectrolyte.

10. The composite material of any one of claims 1-8, wherein
the reinforcement is a first layer;
the electrolyte is a second layer; and
the first layer is in contact with at least one second layer.

11. The composite material of any one of claims 1-8, wherein:
the reinforcement is a porous material; and
the porous material is impregnated with the electrolyte.

12. The composite material of claim 11, wherein the porous material has from about 40% to about 90% porosity.

13. The composite material of claim 11 or 12, wherein the porous material has from about 70% to about 85% porosity.

14. The composite material of any one of claims 11-13, wherein the porous material has about 73% porosity.

15. The composite material of any one of claims 11-14, wherein an average size of pores of the porous material is from about 50 nm to about 500 μm.

16. The composite material of any one of claims 11-15, wherein the average size of pores of the porous material is from about 100 nm to about 10 μm.

17. The composite material of any one of claims 11-16, wherein the average size of pores of the porous material is from about 300 nm to about 1 μm.

18. The composite material of any one of claims 11-17, wherein the average size of pores of the porous material is about 450 nm.

19. The composite material of any one of claims 1-18, wherein the composite material is a film having a thickness from about 1 μm to about 300 μm.

20. The composite material of any one of claims 1-19, wherein the composite material is a film having a thickness from about 25 μm to about 75 μm.

21. The composite material of any one of claims 1-20, wherein the composite material is a film having thickness about 50 μm.

22. The composite material of any one of claims 1-21, wherein the polyelectrolyte further comprises a second repeat unit Z², wherein Z² is a linear C₂₋₈ alkylene or a chemical moiety represented by the following structural formula 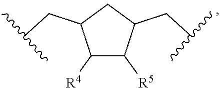
wherein: [symbol]
indicates the point of attachment to other repeat units;
the linear C₂₋₈ alkylene is unsubstituted or substituted with one or more C₁₋₃ alkyl, C₁₋₃ haloalkyl, C₁₋₃ alkyl(C₆₋₁₄ aryl), or —(C₁₋₃ alkylene)O(C₁₋₃ alkylene)C₆₋₁₄ aryl, wherein each aryl is optionally substituted with 1 to 3 C₁₋₃ alkyls or C₁₋₃ haloalkyls; and
R⁴ and R⁵, each independently, is H, a C₁₋₃ alkyl, a C₁₋₃ haloalkyl, a C₃₋₈ alkenyl, a C₁₋₃ alkyl(C₆₋₁₄ aryl), or a —(C₁₋₃ alkylene)O(C₁₋₃ alkylene)(C₆₋₁₄ aryl), wherein each aryl is optionally substituted with 1 to 3 C₁₋₃ alkyls or C₁₋₃ haloalkyls, or
R⁴ and R⁵ taken together with the carbon atoms to which they are attached form a C₅₋₇ cycloalkyl; wherein the C₅₋₇ cycloalkyl is optionally substituted with a —C(O)O(C₁₋₃ alkyl) or a C₃₋₈ alkenyl.

23. The composite material of any one of claims 1-22, wherein the polyelectrolyte comprises at least a first polymer chain and a second polymer chain, and the first polymer chain is cross-linked to the second polymer chain.

24. The composite of claim 23, wherein the polyelectrolyte further comprises at least one connecting moiety, wherein the connecting moiety is selected from a moiety represented by the following structural formulas 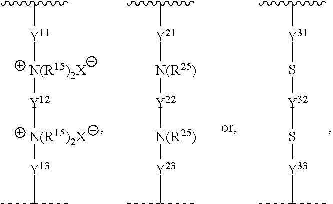
wherein [symbol]
indicates the point of attachment of the connecting moiety to the first polymer chain; [symbol]
indicates the point of attachment of the connecting moiety to the second polymer chain;
Y¹¹, Y¹³, Y²¹, and Y²³, each independently, is a C₁₋₃ alkylene;
Y³¹ and Y³³, each independently, is a C₁₋₅ alkylene;
R¹⁵ and R²⁵, each independently, is a C₁₋₄ alkyl; and
Y¹², Y²³ and Y³², each independently, is a C₂₋₁₀ alkylene or a (C₁₋₃ alkylene)(C₆ aryl)(C₁₋₃ alkylene).

25. The composite material of any one of claims 1-22, wherein the polyelectrolyte comprises at least a first polymer chain, a second polymer chain, and a third polymer chain, and the first polymer chain is cross-linked to the second polymer chain and to the third polymer chain.

26. The composite material of claim 25, wherein the polyelectrolyte further comprises at least one connecting moiety, wherein the connecting moiety is selected from a moiety represented by the following structural formulas 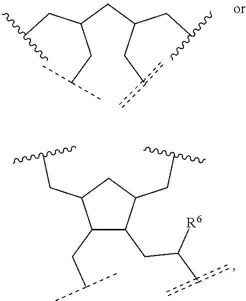
wherein [symbol]
indicates the point of attachment of the connecting moiety to the first polymer chain; [symbol]
indicates the point of attachment of the connecting moiety to the second polymer chain; [symbol]
indicates the point of attachment of the connecting moiety to the third polymer chain; and
R⁶ is H or a —C(O)O(C₁₋₃ alkyl).

27. The composite material of any one of claims 1-26, wherein R¹¹ is methyl.

28. The composite material of any one of claims 1-27, wherein R²¹ is methyl.

29. The composite material of any one of claims 1-27, wherein R³¹ is methyl.

30. The composite material of any one of claims 1-29, wherein R⁴¹ is methyl.

31. The composite material of any one of claims 1-30, wherein R¹² is a C₁₋₄ alkyl.

32. The composite material of any one of claims 1-31, wherein R¹² is methyl.

33. The composite material of any one of claims 1-31, wherein R¹² is isopropyl.

34. The composite material of any one of claims 1-33, wherein R²² is a C₁₋₄ alkyl.

35. The composite material of any one of claims 1-34, wherein R²² is methyl.

36. The composite material of any one of claims 1-34, wherein R²² is isopropyl.

37. The composite material of any one of claims 1-36, wherein R³² is a C₁₋₄ alkyl.

38. The composite material of any one of claims 1-37, wherein R³² is methyl.

39. The composite material of any one of claims 1-37, wherein R³² is isopropyl.

40. The composite material of any one of claims 1-39, wherein R⁴² is a C₁₋₄ alkyl.

41. The composite material of any one of claims 1-40, wherein R⁴² is methyl.

42. The composite material of any one of claims 1-40, wherein R⁴² is isopropyl.

43. The composite material of any one of claims 1-42, wherein R¹³ is a C₅₋₇ cycloalkyl.

44. The composite material of any one of claims 1-43, wherein R¹³ is cyclohexyl.

45. The composite material of any one of claims 1-42, wherein R¹³ is a C₁₋₄ alkyl.

46. The composite material of claim 45, wherein R¹³ is methyl.

47. The composite material of any one of claims 1-46, wherein R²³ a C₅₋₇ cycloalkyl.

48. The composite material of any one of claims 1-47, wherein R²³ is cyclohexyl.

49. The composite material of any one of claims 1-46, wherein R²³ is C₁₋₄ alkyl.

50. The composite material of claim 49, wherein R²³ is methyl.

51. The composite material of any one of claims 1-50, wherein R³³ is a C₅₋₇ cycloalkyl.

52. The composite material of any one of claims 1-51, wherein R³³ is cyclohexyl.

53. The composite material of any one of claims 1-50, wherein R³³ is a C₁₋₄ alkyl.

54. The composite material of claim 53, wherein R³³ is methyl.

55. The composite material of any one of claims 1-54, wherein R⁴³ a C₅₋₇ cycloalkyl.

56. The composite material of any one of claims 1-55, wherein R⁴³ is cyclohexyl.

57. The composite material of any one of claims 1-54, wherein R⁴³ is a C₁₋₄ alkyl.

58. The composite material of claim 57, wherein R⁴³ is methyl.

59. The composite material of any one of claims 22-58, wherein Z² is a linear substituted or unsubstituted C₂₋₈ alkylene.

60. The composite material of any one of claims 22-59, wherein Z² is a linear C₈ alkylene.

61. The composite material of claim 60, wherein the linear C₈ alkylene is substituted with a C₁₋₃ alkyl, a C₁₋₃ haloalkyl, a C₁₋₃ alkyl(C₆₋₁₄ aryl), or a —(C₁₋₃ alkylene)O(C₁₋₃ alkylene)(C₆₋₁₄ aryl).

62. The composite material of claim 60 or 61, wherein the linear C₈ alkylene is substituted with —CH₂F, —CH₂CH₂C₆H₅, or —CH₂OCH₂(3,5-(CF₃)₂C₆H₃).

63. The composite material of any one of claims 22-60, wherein Z² is an unsubstituted linear C₈ alkylene.

64. The composite material of any one of claims 22-58, wherein Z² is a chemical moiety represented by the following structural formula

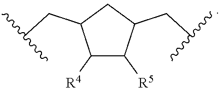

65. The composite material of claim 64, wherein R⁴ and R⁵ is each independently H or a C₃₋₈ alkenyl.

66. The composite material of claim 65, wherein R⁴ and R⁵ taken together with the carbon atoms to which they are attached form a C₅₋₇ cycloalkyl.

67. The composite material of claim 66, wherein the C₅₋₇ cycloalkyl is substituted with a —C(O)O(C₁₋₃ alkyl).

68. The composite material of claim 22, wherein the polyelectrolyte is represented by structural formulas V or VI: 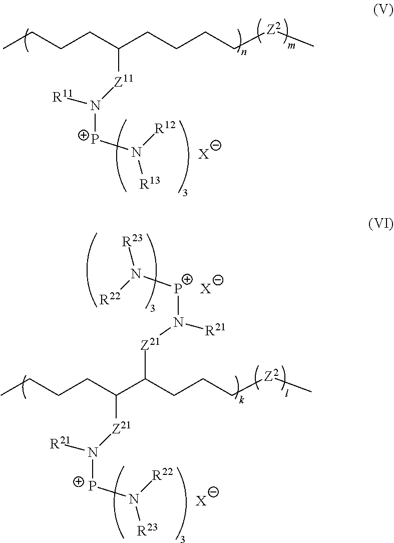
wherein
n is an integer from 2 to 2000;
m is an integer from 0 to 10000;
k is an integer from 1 to 1000;
l is an integer from 0 to 10000;

69. The composite material of claim 68, wherein the polyelectrolyte is represented by structural formula VII:

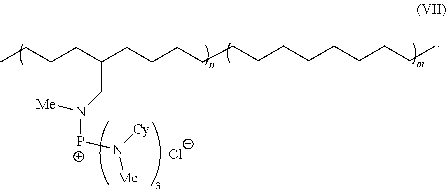

70. The composite material of any one of claims 1-69, wherein the polyelectrolyte comprises from about 10 mol-% to about 100 mol-% of the first repeat units represented by the structural formula I.

71. The composite material of any one of claims 1-70, wherein the polyelectrolyte comprises from about 20 wt. % to about 60 wt. % of the first repeat units represented by the structural formula I.

72. The composite material of any one of claims 1-71, wherein the polyelectrolyte comprises from about 30 mol-% to about 50 mol-% of the first repeat units represented by the structural formula I.

73. The composite material of any one of claims 1-72, wherein the polyelectrolyte comprises about 37 mol-% of the first repeat units represented by the structural formula I.

74. The composite of any one of claims 23-68 and 70-73, wherein degree of cross-linking of the polyelectrolyte is from about 5% to about 15%.

75. The composite material of any one of claims 1-74, wherein the molecular weight of the polyelectrolyte is from about 5,000 g/mol to about 1,000,000 g/mol.

76. The composite material of any one of claims 1-75, wherein the molecular weight of the polyelectrolyte is from about 200,000 g/mol to about 800,000 g/mol.

77. The composite material of any one of claims 1-76, wherein the polyelectrolyte has a molecular weight from about 300,000 g/mol to about 500,000 g/mol.

78. The composite material of any one of claims 1-77, wherein the polyelectrolyte has a molecular weight about 360,000 g/mol.

79. A membrane, comprising a film of the composite material of any one of claims 1-78.

80. A membrane electrode assembly, comprising a membrane of claim 79 and an electrode.

81. An electrochemical device, comprising a membrane electrode assembly of claim 80 and a current collector.

82. The electrochemical device of claim 81, wherein the device is an electrolyzer.
